(19) United States
(12) Patent Application Publication
(10) Pub. No.: US 2024/0097920 A1
(43) Pub. Date: Mar. 21, 2024

(54) METHODS AND APPARATUS FOR MESH NETWORK COMMUNICATIONS AND ENHANCING THE SECURITY AND STEALTH IN COMMUNICATION NETWORKS

(71) Applicant: Crius Technology Group, Inc., Austin, TX (US)

(72) Inventors: Glenn John Robertson, Buda, TX (US); Michael D. Salinas, Austin, TX (US)

(73) Assignee: Crius Technology Group, Inc., Austin, TX (US)

(21) Appl. No.: 18/510,342

(22) Filed: Nov. 15, 2023

Related U.S. Application Data
(63) Continuation-in-part of application No. 17/705,664, filed on Mar. 28, 2022.
(60) Provisional application No. 63/280,068, filed on Nov. 16, 2021.

(51) Int. Cl. H04L 9/32; H04L 9/08; H04L 67/12

(52) U.S. Cl. CPC H04L 9/3271; H04L 9/0869; H04L 9/0894; H04L 67/12

(57) ABSTRACT

Methods, apparatus, and techniques for enhancing the security of data stored in a network, enhancing the stealth of a wireless communication network, for communications between network nodes of a mesh network having multi-modal, multi-channel, and/or multi-frequency band communication capabilities, and for securely authenticating nodes joining a network.

### CROSS-REFERENCE TO RELATED APPLICATION

This patent application claims priority as a continuation in part of U.S. patent application Ser. No. 17/705,664 filed Mar. 28, 2022, which claims priority to U.S. Provisional Patent Application No. 63/280,068 filed on Nov. 16, 2021, entitled METHODS, SYSTEMS, AND APPARATUS FOR NETWORK COMMUNICATIONS AND OPERATION, which are incorporated by reference herein in their entireties.

### FIELD OF THE INVENTION

The present application relates to communication network operation, and particularly mesh networks.

### BACKGROUND

This application relates generally to the field of network communications. More particularly, the application pertains to methods and apparatus for enhancing the security of data stored in a network, stealth of a wireless communication network, and communications between network nodes of a mesh network having multi-modal, multi-channel, and/or multi-frequency band communication capabilities. The application also pertains to methods and apparatus for securely authenticating nodes joining a network.

### SUMMARY

In accordance with an embodiment, a method comprises splitting the original data file into N ordered segments, where N is an integer greater than 1, assigning each of the N segments to a node of the network capable of storing data, transmitting each of the N segments to the network node to which it has been assigned, constructing a key containing information as to the network node at which each segment of the original data file is stored and an order of the segments, and deleting the original data file.

In accordance with a further embodiment, computer program product comprises a non-transitory computer-readable storage medium containing computer program code, wherein the computer program code, when executed by one or more processors, causes the one or more processors to perform operations, the computer program code comprising instructions to split an original data file into N ordered segments, where N is an integer greater than 1, assign each of the N segments to a node of a communication network capable of storing data, transmit each of the N segments to the network node to which it has been assigned, construct a key containing information as to the network node at which each segment of the original data file is stored and an order of the segments, and delete the original data file.

In accordance with an embodiment, a method of transmitting data wirelessly in a mesh network comprised of a plurality of network nodes having multi-modal communication capabilities, including wireless communication modes comprises: determining first intervals during which communication via wireless communication modes will be disabled in the mesh network and second intervals during which communication via wireless communication modes will be enabled, disabling wireless communication modes of the nodes of the mesh network during the first intervals, during the first intervals, storing data that is intended for wireless transmission in at least one node of the mesh network, and during the second intervals, wirelessly transmitting the stored data that is intended for wireless transmission from at least one node of the mesh network.

In accordance with a further embodiment, computer program product comprises a non-transitory computer-readable storage medium containing computer program code, wherein the computer program code, when executed by one or more processors, causes the one or more processors to perform operations, the computer program code comprising instructions to determine first intervals during which communication via wireless communication modes will be disabled in the mesh network and second intervals during which communication via wireless communication modes will be enabled, disable wireless communication modes of the nodes of the mesh network during the first intervals, store data in the nodes of the mesh network that is intended for wireless transmission during the first intervals, and wirelessly transmit the stored data that is intended for wireless transmission from at least one node of the mesh network during the second intervals.

In accordance with an embodiment, a method implemented in a wireless network comprising a plurality of authorized network nodes operating on a first communication frequency channel comprises determining a security breach in the network and, responsive to a detection of a security breach of the network, transmitting a first message to the authorized nodes of the network instructing the authorized nodes to switch to a second communication frequency channel.

In accordance with another embodiment, a method implemented in a wireless network comprising a plurality of authorized multi-modal network nodes operating in a first communication mode comprises monitoring the wireless network for the presence of unauthorized nodes and, responsive to a detection of an unauthorized node using the network, transmitting a first message to the authorized nodes of the network instructing the authorized nodes to switch to a second communication mode.

In accordance with a further embodiment, a computer program product comprises a non-transitory computer-readable storage medium containing computer program code, wherein the computer program code, when executed by one or more processors, causes the one or more processors to perform operations, the computer program code comprising instructions to cause a node of a communication network to determine a security breach in the network and, responsive to a detection of a security breach of the network, transmit a first message to the authorized nodes of the network instructing the authorized nodes to switch to a second communication frequency channel.

In accordance with another embodiment, a method implemented in a node of wireless network comprising a plurality of authorized network nodes operating on a first communication frequency channel comprises receiving a first message to the authorized nodes of the network instructing the authorized nodes to switch to a second communication frequency channel and, responsive to the first message, switching to the second communication frequency channel.

In accordance with another embodiment, a computer program product comprises a non-transitory computer-readable storage medium containing computer program code, wherein the computer program code, when executed by one or more processors, causes the one or more processors to perform operations, the computer program code comprising instructions to cause a node of a communication network to receive a first message to the authorized nodes of the network instructing the authorized nodes to switch to a second communication frequency channel and, responsive to the first message, switch to the second communication frequency channel.

In accordance with another embodiment, a method performed in a radio communication device attempting to join a communication network of authenticating the radio communication device to the network comprises encrypting a Media Access Control (MAC) address of the radio communication device using a private encryption key of the radio communication device; encrypting a copy of a public encryption key of the radio communication device and the encrypted MAC address using a public encryption key of a network it is attempting to join; transmitting the encrypted copy of the public encryption key and encrypted MAC address to the network; receiving from the network, responsive to the transmission, permission to join the network; and joining the network.

In accordance with another embodiment, a method of authenticating a radio communication device attempting to join a communication network comprises: receiving from a radio communication device a request to join the communication network: transmitting an authentication challenge to the radio communication device; receiving a challenge response message from the radio communication device, the message comprising a public encryption key of the radio communication device and a Media Access Control (MAC) address of the radio communication device encrypted with a private encryption key of the radio communication device, wherein the encrypted MAC address and the public encryption key of the radio communication device are further encrypted with a public encryption key of the network; decrypting the public encryption key and encrypted MAC address in the challenge response message using a private encryption key of the network; further decrypting the encrypted MAC address using the public key of the radio communication device: determining if the MAC address of the radio communication device corresponds to a MAC address that is allowed to join the network; and transmitting a grant of access to the network to the radio communication device if the MAC address of the radio communication device corresponds to a MAC address that is allowed to join the network.

In accordance with a further embodiment, computer program product comprises a non-transitory computer-readable storage medium containing computer program code, wherein the computer program code, when executed by one or more processors, causes the one or more processors to perform operations, the computer program code comprising instructions to cause a communication network having multi-mode communication capabilities including a first radio communication mode of a relatively higher data rate and a second radio communication mode of a relatively lower data rate to: receive from a radio communication device a request to join the communication network; transmit an authentication challenge message to the radio communication device in response to the request; receive a challenge response message from the radio communication device responsive to the authentication challenge message, the challenge response message comprising a public encryption key of the radio communication device and authentication data of the radio communication device encrypted with a private encryption key of the radio communication device, wherein the encrypted authentication data and the public encryption key of the radio communication device are further encrypted with a public encryption key of the network; decrypt the public encryption key and encrypted MAC address in the challenge response message using a private encryption key of the network; further decrypt the encrypted authentication data using the public key of the radio communication device: determine if the MAC address of the radio communication device corresponds to a MAC address that is allowed to join the network; and transmit a grant of access to the network to the radio communication device if the MAC address of the radio communication device corresponds to a MAC address that is allowed to join the network.

### BRIEF DESCRIPTION OF THE DRAWINGS

FIG. 1 is a block diagram illustrating an apparatus for monitoring, controlling, and communicating in accordance with embodiments.

FIG. 2 is a block diagram illustrating an apparatus for monitoring, controlling, and communicating in accordance with embodiments.

FIG. 3 is a block diagram illustrating an apparatus for monitoring, controlling, and communicating in accordance with embodiments.

FIG. 4 is a block diagram illustrating a method for monitoring, controlling, and communicating of devices in accordance with embodiments.

FIG. 5 is a block diagram illustrating a method for monitoring, controlling, and communicating of devices in accordance with embodiments.

FIG. 6 is a diagram illustrating a sample mesh network environment in accordance with an embodiment of the present disclosure.

FIG. 7 illustrates aspects of a clamp for connecting a multifunction communication cube (MCC) to an electrical power circuit, in an embodiment.

FIG. 8 illustrates a method for communicating with, identifying, monitoring, and controlling electronic devices connected to a circuit, in an embodiment.

FIG. 9 illustrates a system for communicating with, identifying, monitoring, and controlling electronic devices connected to a circuit, in an embodiment.

FIG. 10 illustrates a system for communicating with, identifying, monitoring, and controlling electronic devices connected to a circuit, in an embodiment.

FIG. 11 is a schematic diagram illustrating a system for facilitating self-healing of a network according to an embodiment of the present disclosure.

FIG. 12 is a schematic diagram of a machine in the form of a computer system within which a set of instructions, when executed, may cause the machine to facilitate self-healing of a network.

FIG. 13A is a block diagram illustrating a system for transmitting data over medium and high voltage power lines in accordance with an embodiment.

FIG. 13B is a block diagram illustrating an apparatus for monitoring, controlling, and communicating in accordance with embodiments for medium and high voltage line applications.

FIG. 14A is a block diagram illustrating components for performing data multiplexing in a multi-communication-mode in accordance with embodiments.

FIG. 14B is a block diagram illustrating components for performing data multiplexing in a multi-communication-mode in accordance with alternate embodiments.

FIG. 15 is a timing diagram illustrating data block transmission timing during data multiplexing in accordance with embodiments.

FIG. 16 is a block diagram showing components of a network node in which control plane communications are transmitted and received in a back channel of a communication mode different than the communication mode of user data in accordance with embodiments.

FIG. 17 is a block diagram showing components of a network node in which control plane communications are transmitted and received in a back channel of a communication mode different than the communication mode of user data in accordance with alternate embodiments.

FIG. 18A is a block diagram of components of a network node operable in a multi-mesh environment in accordance with embodiments.

FIG. 18B shows the node data and routing algorithm block of FIG. 18A in more detail.

FIG. 19 is a signal flow diagram illustrating network access administration in accordance with embodiments.

FIG. 20 is a diagram illustrating encryption layers in an access request packet in accordance with embodiments.

FIG. 21 is a flowchart illustrating a process for encrypting an access request packet in accordance with embodiments.

FIG. 22 is a diagram illustrating a communication network comprising stationary nodes and mobile nodes in accordance with embodiments.

FIG. 23 is a flowchart illustrating a process for enhancing security in a network by distributing storage of files throughout the network in accordance with embodiments.

FIG. 24 is a flowchart illustrating a process for retrieving a file that has been stored in a network in a distributed manner, for example, per the process of FIG. 23, in accordance with embodiments.

FIG. 25 is a block diagram illustrating a system for burst radio communications in accordance with embodiments.

FIG. 26 is a flow diagram illustrating a method for burst radio communications in accordance with embodiments.

### DETAILED DESCRIPTION OF THE DRAWINGS

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

U.S. Published Patent Application No. 2023/0051350 (patent application Ser. No. 17/398,224, entitled METHODS AND APPARATUS FOR MULTI-PATH MESH NETWORK ENCRYPTION AND KEY GENERATION) filed Aug. 10, 2021, and co-owned with the present application is incorporated herein by reference in its entirety.

With the growth of the Internet of Things, existing devices are becoming networked in order to enable the monitoring, controlling, and communicating of the devices remotely. Merely as one example, lighting and lighting systems are devices that are becoming networked in order to control power, color, and brightness. Currently, the method for incorporating a control system into an existing lighting system may be carried out by running wire or cable from a control device/panel to the lighting system. The running of the wire or cable may cost $10,000 per floor and may require days to accomplish. Additionally, the control device/panel may cost between $10,000 to $15,000. With such economics, the implementation of the Internet of Things to existing lighting systems has been slow in coming.

A method, apparatus, and system for monitoring, controlling, and communicating of devices may be described. The method, apparatus, and system may use a radio communication to power line communication bridge and networking system for the monitoring, controlling, and communicating of devices such as lighting systems. This method, apparatus, and system may not require the running of wire or cable and may be deployed in hours, not days, at a fraction of the cost of existing control systems.

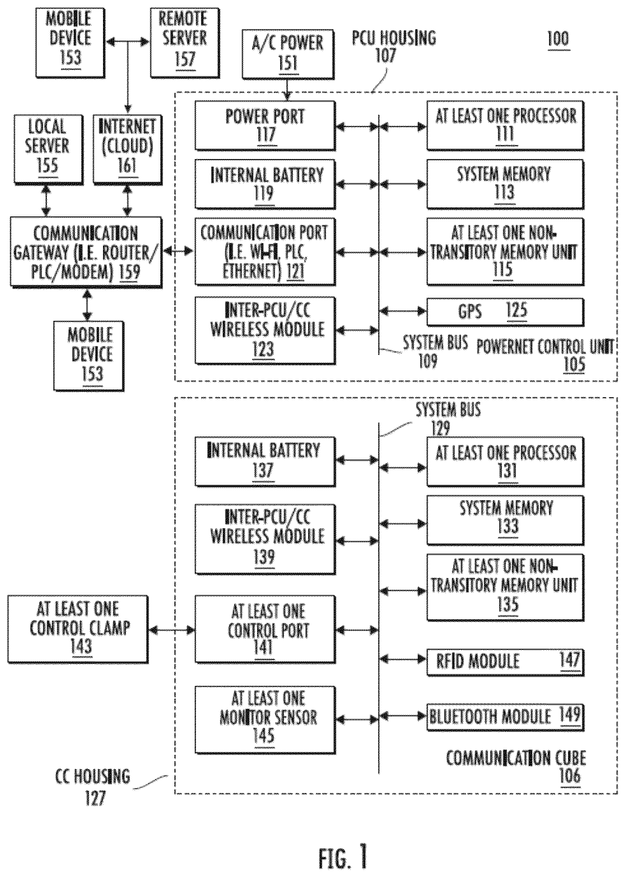

FIG. 1 is a block diagram illustrating an apparatus for monitoring, controlling, and communicating in accordance with embodiments.

In embodiments, apparatus 100 may comprise at least one powernet control unit and at least one communication cube. The powernet control unit (PCU) 105 may comprise a PCU housing 107, a system bus 109, at least one processor 111, system memory 113, at least one non-transitory memory unit 115, a power port 117, an internal battery 119, a communication port 121, an inter-PCU/CC wireless module 123, and a GPS module 125, all of which may be directly or indirectly coupled to each other. The communication cube (CC) 106 may comprise a CC housing 127, a system bus 129, at least one processor 131, system memory 133, at least one non-transitory memory unit 135, an internal battery 137, an inter-PCU/CC wireless module 139, at least one control port 141, at least one control clamp 143, at least one monitor sensor 145, a RFID module 147, and a Bluetooth module 149, all of which may be directly or indirectly coupled to each other. In the installation of the apparatus, the PCU 105 may be mounted on the back of a flat electrical strike plate and may be powered by the internal battery 119 or by A/C power 151 through the power port 117 in embodiments. In embodiments, the communication port 121 may comprise at least one of a Wi-Fi radio, an Ethernet port, and a power line communication (PLC) bridge and may allow for the communication between powernet control units 105 and external control and monitoring devices such as mobile device 153, local server 155, and/or remote server 157. For Wi-Fi, PLC, and Ethernet, communication may be established through a communication gateway 159 such as a router/PLC/modem. Using a communication cube control web portal or a communication cube control app (PCU/CC dashboard application), at least one of the local servers 155 and the mobile device 153 may be used to communicate with the PCU 105 and the CC 106 through the communication gateway 159. Additionally, the communication gateway 159 may be connected to the Internet 161, thus making it possible for the remote server 157 and/or the mobile device 153, using a communication cube control web portal or a communication cube control app, to communicate with the PCU 105 and the CC 106. The PCU 105 may communicate with the CC 106 through the inter-PCU/CC wireless module 123 of the PCU 105 with the inter-PCU/CC wireless module 139 of the CC 106. The inter-PCU/CC wireless modules 123, 139 may comprise at least one of a Bluetooth radio, 6LoWPan radio, XBee, and ZigBee radio. Bluetooth, 6LoWPan, XBee, and ZigBee may encompass all past, current, and future versions of the wireless protocols. The powernet control units 105, which are connected to the PLC may be nodes, which, in turn, may be in communication with the communication cubes 106. Each PCU node may be capable of identifying the communication cubes 106 which are connected to it. This network of communication cubes 106 connected to PCU nodes which are connected via PLC may be referred to as a powernet. A device, such as a CC, having communication capabilities in more than one protocol (e.g., Ethernet, Wi-Fi, ZigBee, PLC) will sometimes be referred to herein as being multi-modal, multi-protocol, having multi-modal communication capabilities, and the like.

In embodiments, the CC 106 may be mounted within or co-located with another electronic device and may be powered by the internal battery 137 or by one of the at least one control clamp 143 spliced into a power line, such as the power line for the electronic device with which it may be associated. The control clamp may be designed to splice the power line without having to shut down power to the associated device. After splicing the power line, direct power to the associated device may be removed and the CC 106 may now be capable of controlling the lighting fixture or device, thus enabling control for dimming, color, and other primary and secondary functions such as, but not limited to Li-Fi management and emergency controls. Since the control clamp 143 is tapped into the power line, the control clamp 143 may also be able to provide power to the CC 106 through the control port 141. The CC 106 may also comprise at least one monitor sensor 145 to monitor for occupancy in the area of the lighting fixture as well as the lighting fixture location and status.

In embodiments, the RFID module 147 and Bluetooth module 149 of the CC 106 may be used to establish a beacon. The RFID module 147 may be used to monitor the space around the CC for any RFID transmitters. In a hospital setting, the RFID transmitters may be mounted onto tables, drug carts, wheelchairs, etc. The CC 106 may then be able to keep track of the RFID transmitters in the vicinity of the CC. The Bluetooth module 149 may be used to continuously ping the area around the CC for any nearby Bluetooth enabled devices. The vast majority of phones and devices since 2006 may respond to this pinging, thus enabling the CC 106 to map and monitor the number of people that are carrying Bluetooth phones and devices that are in the vicinity of the CC. The processing of the RFID and Bluetooth monitoring may be handled locally by the at least one processor 131 of the CC 106. By having this map of people and things, if a patient is looking for a particular facility within the hospital, the path of least resistance (i.e., least congestion) for the patient to get to the particular facility may be determined from the data collected from RFID monitoring and Bluetooth pinging. This path may be transmitted to the patient who is running the hospital's mobile application on a Bluetooth enabled phone. In embodiments, the Bluetooth module 149 may be used to transmit offers, promotions, or other information to an individual with a Bluetooth enabled phone running a particular store or promotion mobile application. In such a scenario, if a customer is shopping at a grocery store and is running a store's mobile application on a Bluetooth enabled phone and the customer approaches the soft drink aisle, the CC 106 may be able to determine that the customer is in the soft drink aisle and may be able to present the customer offers and promotions for products that are also in the soft drink aisle. The CC 106 may present offers for products that are available since the CC 106 may use its RFID module 147 to detect for products labeled with RFID tags.

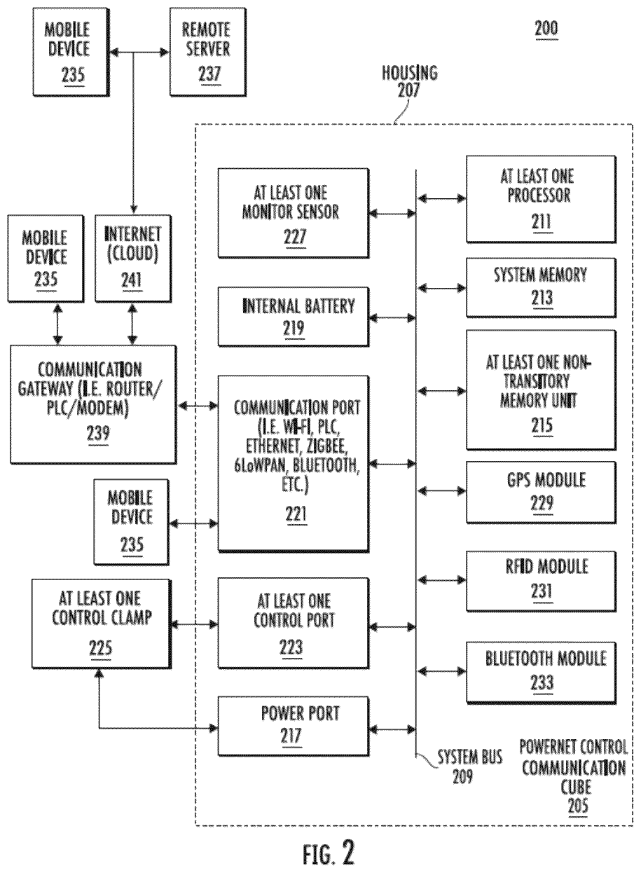

FIG. 2 is a block diagram illustrating an apparatus for monitoring, controlling, and communicating in accordance with embodiments.

In embodiments, apparatus 200 may comprise at least one powernet control communication cube 205. The powernet control communication cube (PCCC) 205 may comprise a housing 207, a system bus 209, at least one processor 211, system memory 213, at least one non-transitory memory unit 215, a power port 217, an internal battery 219, a communication port 221, at least one control port 223, at least one control clamp 225, at least one monitor sensor 227, a GPS module 229, an RFID module 231, and a Bluetooth module 233, all of which may be directly or indirectly coupled to each other.

In embodiments, the PCCC 205 may be mounted within another electronic device or on the back of a flat electrical strike plate and may be powered by the internal battery 219 or by using one of the control clamps 225 coupled to the power port 217 to tap into a power line. Alternatively, the power port 217 may draw its power internally from one of the control clamps 225 connected to the control port 223. The communication port 221 may comprise at least one of a Wi-Fi radio, a PLC bridge, an Ethernet port, XBee radio, ZigBee radio, 6LoWPan radio, and a Bluetooth radio and may allow for the communication between powernet control communication cubes 205 and external control and monitoring devices, such as mobile device 235 and remote server 237. Bluetooth, 6LoWPan, XBee, and ZigBee may encompass all past, current, and future versions of the wireless protocols. For Wi-Fi, PLC, and Ethernet, communication may be established through a communication gateway 239 such as a router/PLC/modem. Using a PCCC control web portal or a PCCC control app (PCCC dashboard application), the mobile device 235 may be used to communicate with the PCCC 205 through the communication gateway 239. Additionally, the communication gateway 239 may be connected to the Internet 241, thus making it possible for at least one of the remote servers 237 and the mobile device 235, using a PCCC control web portal or a PCCC control app, to communicate with the PCCC 205. Using the Bluetooth radio of the communication port 221, the mobile device 235 may also be capable of communicating with the PCCC 205 through the communication port 221. The powernet control communication cubes 205 may also communicate with each other through the communication port 221 using the Bluetooth radio, 6LoWPan radio, XBee, and/or ZigBee radio. The powernet control communication cubes 205 which are connected to the PLC may be nodes which in turn may be in communication with the powernet control communication cubes 205 which may not be connected to the PLC. Each PCCC node may be capable of identifying the powernet control communication cubes 205 which may be connected to it. This network of powernet control communication cubes 205 connected to PCCC nodes which are connected via PLC may be referred to as a powernet. Lastly, the GPS module 229 may provide location data for the PCCC 205 and may allow for the traceability of the PCCC 205 in event of its theft.

In embodiments, the RFID module 231 and Bluetooth module 233 of the PCCC 205 may be used to establish a beacon and to monitor the space around the PCCC or device for any RFID transmitters as described above in connection with the CC 106 of FIG. 1.

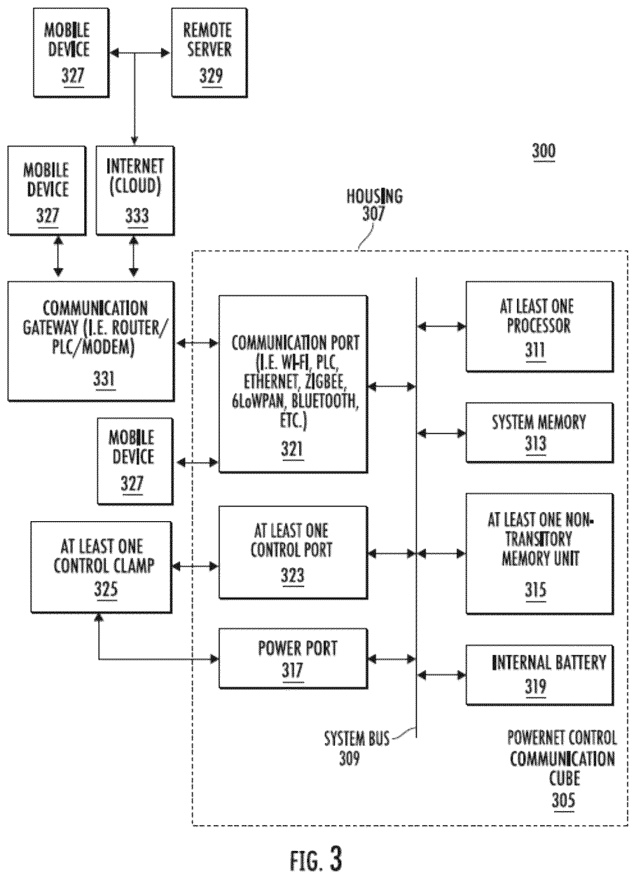

FIG. 3 is a block diagram illustrating another apparatus for monitoring, controlling, and communicating in accordance with embodiments.

In embodiments, apparatus 300 may comprise at least one powernet control communication cube 305. The powernet control communication cube (PCCC) 305 may comprise a housing 307, a system bus 309, at least one processor 311, system memory 313, at least one non-transitory memory unit 315, a power port 317, an internal battery 319, a communication port 321, at least one control port 323, and at least one control clamp 325, all of which may be directly or indirectly coupled to each other.

In embodiments, the PCCC 305 may be mounted within another electronic device or on the back of a flat electrical strike plate and may be powered by the internal battery 319 or by using one of the control clamps 325 coupled to the power port 317 to tap into a power line. Alternatively, the power port 317 may draw its power internally from one of the control clamps 325 connected to the control port 323. The communication port 321 may comprise at least one of a Wi-Fi radio, a PLC bridge, an Ethernet port, XBee radio, ZigBee radio, 6LoWPan radio, and a Bluetooth radio and may allow for the communication between powernet control communication cubes 305 and external control and monitoring devices such as at least one of a mobile device 327 and a remote server 329. Bluetooth, 6LoWPan, XBee, and ZigBee may encompass all past, current, and future versions of the wireless protocols. For Wi-Fi, PLC, and Ethernet, communication may be established through a communication gateway 331 such as a router/PLC/modem. Using a PCCC control web portal or a PCCC control app (PCCC dashboard application), the mobile device 327 may be used to communicate with the PCCC 305 through the communication gateway 331. Additionally, the communication gateway 331 may be connected to the Internet 333, thus making it possible for at least one of the remote servers 329 and the mobile device 327, using a PCCC control web portal or a PCCC control app, to communicate with the PCCC 305. Using the Bluetooth radio of the communication port 321, the mobile device 327 may also be capable of communicating with the PCCC 305 through the communication port 321. The powernet control communication cubes 305 may also communicate with each other through the communication port 321 using the Bluetooth radio, 6LoWPan radio, XBee, and/or ZigBee radio. The powernet control communication cubes 305 which may be connected to the PLC may be nodes which in turn may be in communication with the powernet control communication cubes which are not connected to the PLC. Each PCCC node may be capable of identifying the powernet control communication cubes 305 which may be connected to it. This network of powernet control communication cubes 305 connected to PCCC nodes which are connected via PLC may be referred to as a powernet.

In embodiments, the PCCC 305 may be used to control a single device (e.g., a lamp), a single fixture, and/or a series of devices. For such an embodiment, the PCCC 305 may be mounted within the device and may be powered by the internal battery 319 or by one of the at least one control clamp 325 spliced into the power line to the device. The control clamp 325 may be designed to splice the power line to a device without having to shut down power to the device as previously described in connection with the CC 106 of FIG. 1. After splicing the power line, direct power to the device may be removed and the PCCC 305 may now be capable of controlling the device as such as described above in connection with the CC 106 of FIG. 1. Since the control clamp is tapped into the power line, the control clamp may also be able to provide power to the PCCC 305 through the power port 317. This embodiment was similarly disclosed in FIG. 2, except that in this embodiment, the components not required for controlling a lighting system, (the at least one monitor sensor, the GPS, the RFLD, and Bluetooth) have been eliminated.

In embodiments, the components for communication through the communication gateway may be separated from the components for communication between the powernet control communication cubes 305. In such an embodiment, the powernet control unit may comprise at least one of the Wi-Fi radio, the Ethernet port, and the power line communication (PLC) bridge and the communication cube 305 may comprise at least one of a Bluetooth radio, 6LoWPan radio, and ZigBee radio, as was similarly disclosed in FIG. 1, except that in this embodiment, the components not required for controlling a lighting system or other device (the at least one monitor sensor, the GPS, the RFID, and Bluetooth) have been eliminated.

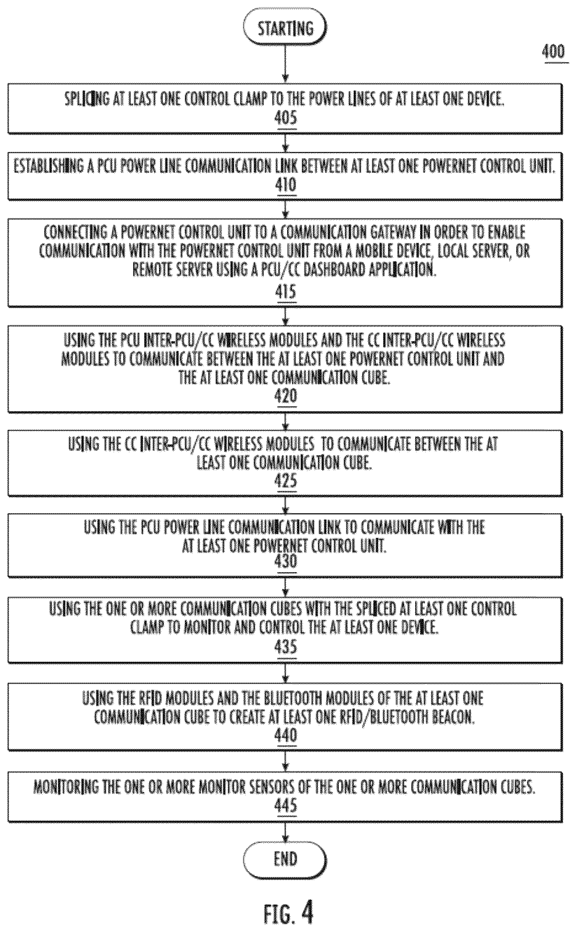

FIG. 4 is a block diagram illustrating a method for monitoring, controlling, and communicating of devices in accordance with embodiments.

In embodiments, PCU code and CC code may be stored on the at least one PCU non-transitory memory unit and the at least one CC non-transitory memory unit, respectively, and executed by the at least one PCU processor and by the at least one CC processor, respectively, to perform a method 400 for monitoring, controlling, and communicating of devices. The method 400 illustrated in FIG. 4 may be performed by the apparatus illustrated in FIG. 1. Processing may begin in method 400 at block 405, wherein at least one control clamp may be spliced to the power lines of at least one device.

At block 410, a PCU power line communication link may be established for communication between at least one powernet control unit.

At block 415, a powernet control unit may be connected to a communication gateway in order to enable communication with the powernet control unit from a mobile device, local server, or remote server using a PCU/CC dashboard application.

At block 420, the PCU inter-PCU/CC wireless modules and the CC inter-PCU/CC wireless modules may be used to communicate between the at least one powernet control unit and the at least one communication cube.

At block 425, the CC inter-PCU/CC wireless modules may be used to communicate between the at least one communication cubes.

At block 430, the PCU power line communication link may be used to communicate with the at least one powernet control unit.

At block 435, the at least one communication cube with the spliced at least one control clamp may be used to monitor and control the at least one device.

At block 440, the RFID modules and the Bluetooth modules of the at least one communication cube may be used to create at least one RFID/Bluetooth beacon.

At block 445, the at least one monitor sensor of the at least one communication cube may be monitored. The at least one monitor sensor may be used to monitor for occupancy in the area of the device as well as the device location and status. Processing may subsequently end after block 445.

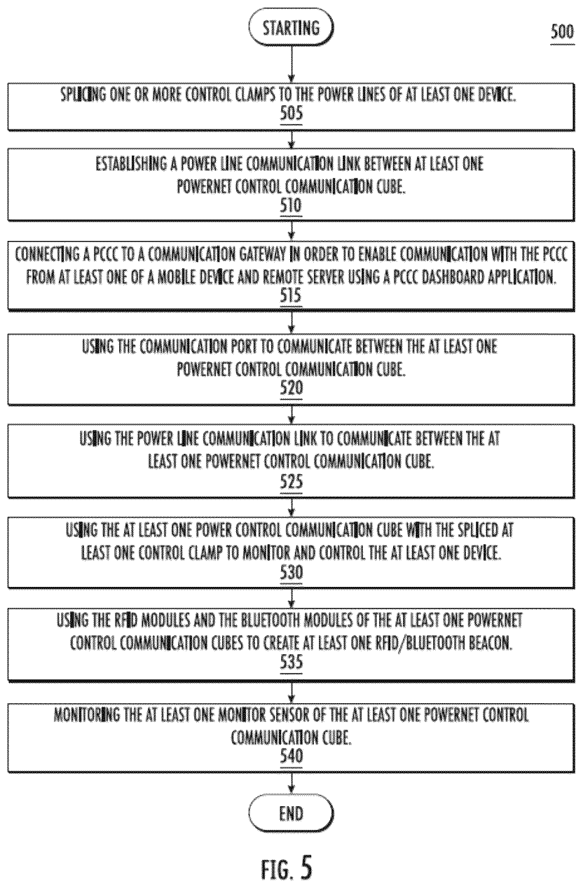

FIG. 5 is a block diagram illustrating a method for monitoring, controlling, and communicating of devices in accordance with embodiments.

In embodiments, PCCC code may be stored on the at least one non-transitory memory unit and may be executed by the at least one processor to perform a method 500 for monitoring, controlling, and communication of devices. The method 500 illustrated in FIG. 5 may be performed by the apparatuses illustrated in FIG. 2 and FIG. 3. Processing may begin in method 500 at block 505, wherein at least one control clamp may be spliced to the power lines of at least one device.

At block 510, a power line communication link may be established for communication between at least one powernet control communication cube.

At block 515, a PCCC may be connected to a communication gateway in order to enable communication with the PCCC from a mobile device and/or remote server using a PCCC dashboard application.

At block 520, the communication port may be used to communicate between the at least one powernet control communication cube.

At block 525, the power line communication link may be used to communicate between the at least one powernet control communication cube.

At block 530, the at least one powernet control communication cube with the spliced at least one control clamp may be used to monitor and control the at least one device.

At block 535, the RFID modules and the Bluetooth modules of the at least one powernet control communication cube may be used to create at least one RFID/Bluetooth beacon.

At block 540, the at least one monitor sensor of the at least one powernet control communication cube may be monitored. The at least one monitor sensor may be used to monitor for occupancy in the area of the device as well as the device location and status. Processing may subsequently end after block 540.

Embodiments described herein relate to a computer storage product with at least one non-transitory memory unit having instructions or computer code thereon for performing various computer-implemented operations. The at least one memory unit are non-transitory in the sense that they do not include transitory propagating signals per se (e.g., a propagating electromagnetic wave carrying information on a transmission medium such as space or a cable). The at least one memory unit and computer code (also can be referred to as code) may be those designed and constructed for the specific purpose or purposes. Examples of at least one memory unit include, but are not limited to: magnetic storage media such as hard disks, floppy disks, and magnetic tape: optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM), and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, Python, C, or other programming languages (e.g., object-oriented programming languages) and development tools. Additional examples of computer code include, but are not limited to, control signals, encrypted code, database code, and compressed code.

As discussed, a single multifunction communications cube (MCC) may have multiple means or subsystems for receiving and transmitting digital information. It will be understood that a multifunction communication cube (MCC) may include all, or a subset, of the same or similar components, features, and functionality of apparatus 100, apparatus 200, and apparatus 300 described in detail elsewhere in this application. The MCC may use its communications subsystems or inputs (Wi-Fi, XBee, ZigBee, Bluetooth, PCL, Ethernet, etc.) to generate a “digital impression” or “digital profile” including digital impression information of the devices in its environment. The digital impression may contain essentially all, or a subset of, signal information across all of the CC's detection means for each and every device that the MCC can detect. The digital impression information collected about different devices in the environment of the MCC may differ in relation to signal information available and collected by the CC. The MCC may monitor all of the inputs simultaneously, or in any suitable order to generate such a digital impression. Monitoring of inputs by the MCC may include monitoring all or a subset of communications subsystems of the CC. This digital impression may be limited only by the inherent limitations of the different input methodologies or input subsystems of the CC. In an embodiment, for example, the CC's ability to monitor devices via its PLC inputs may be limited to devices connected to an electrical circuit accessible to the CC, while the devices observable via the CC's Bluetooth and Wi-Fi inputs may be limited to the communication reception ranges determined by each device's Bluetooth antenna range and Wi-Fi antenna range. The signal information from all inputs available to the MCC may be aggregated to generate the digital impression. Multiple CCs with overlapping sensor ranges may have separate digital impressions that contain devices that overlap, or alternatively, may be aggregated together to create a single, more thorough or complete digital impression of the devices around the plurality of networked CCs. In an embodiment, for example, a first MCC and second MCC in communication, directly or indirectly via other intermediate CC's relaying communications information between the first MCC and second CC, may have combined, coordinated, or cooperative capability to identify, monitor, and interact with devices via PLC inputs connected to any electrical circuit accessible or connected to either the first MCC and the second CC, and further may have combined, coordinated or cooperative capability to identify, monitor and interact with the same or other devices via Bluetooth and Wi-Fi inputs within wireless communication range of both the first MCC and second CC. In such an embodiment, for example, digital impressions of each of a plurality of devices may include digital impression information obtained via PLC inputs, Bluetooth inputs, and Wi-Fi inputs, of each and every device observable, directly or indirectly, by the first MCC and second CC.

In an exemplary scenario, if a MCC is installed into a powerline circuit in a room with a Wi-Fi enabled smart TV that is connected to the same powerline circuit as the CC, a Bluetooth and Wi-Fi enabled cell phone sitting by itself on a desk in the next room over, and a ZigBee enabled smoke detector connected to a separate powerline circuit in the hall between the two rooms, the MCC may receive both a PLC signal and a Wi-Fi signal from the TV, both Wi-Fi and Bluetooth signals from the cell phone, and a ZigBee signal from the smoke detector. The digital impression generated by the MCC would comprise all of these signals together.

The CC's onboard processor may aggregate this sensor data in order to generate the digital impression of the CC's environment. The MCC may then use its processor and information contained on its onboard memory to identify digital signatures of the different devices constituting the digital impression. If the digital impression cannot be disambiguated to determine the unique signatures identifying the constituent devices, the MCC may use one or more of its communications pathways to transmit the digital impression to a remote server, which may have access to more data and processing capabilities than the CC's onboard hardware in order to disambiguate the digital impression and determine what devices are being sensed by the CC. Once the digital impression has been disambiguated and the unique devices sensed by the MCC are identified that information along with control information for those devices may be communicated from the remote server back to the MCC through a suitable communication network. The unique device information may comprise information such as the make and model of the device, and may further comprise control information including, but not limited to control signals compatible with the identified device through one or more communications means, and a hierarchy of what communications means are preferred for controlling said device. Whether or not the MCC can determine the devices constituting the digital impression through onboard processing versus offboard processing at a remote server may be a question of the CC's form factor and current hardware limitations.

Once the MCC has either determined the identity of the devices that it sensed in its digital impression, or has received such information from the remote server, the MCC may then use any of the output methods available to it to communicate with and control the unique devices whose signals were include in the CC's digital impression. The determination of what communication means should be used to control which unique device may be associated with the information used to identify of the unique devices and may be determined when the unique devices are identified. This control and control preference information may be stored either on the CC's or on the remote server's memory. This selection of the means by which to control the devices may be limited to the manner in which the MCC can communicate with that particular device (it would not be helpful for the MCC to try to control a Wi-Fi enabled TV via Wi-Fi if either the MCC does not possess Wi-Fi functionality, or if the MCC is in only powerline communication with the TV).

Continuing with the example provided above, once the MCC has formed a digital impression of its environment, including the PLC signature of the TV, the Wi-Fi signatures of the TV and the smartphone, the Bluetooth signature of the smartphone, and the ZigBee signature of the smoke detector, it may transmit this impression to a remote server, and receive back from the server information indicating the three devices and their control preferences. The stored device information indicates that the TV may be controlled via PLC, infra-red (IR), and Wi-Fi, but prefers to be controlled via IR or Wi-Fi; the smartphone prefers to be controlled by Bluetooth rather than Wi-Fi; and the smoke detector can be controlled by PLC or ZigBee and has no preference on which is better. In such a case, the MCC would control the TV via Wi-Fi as it is preferred over PLC and the MCC does not possess IR; the smartphone via Bluetooth as it is preferred over PLC: and the smoke detector via ZigBee as it is the only connection that the MCC has to that device.

In embodiments, the MCC may be limited to having fewer than all of the possible input and communications means. For example, one MCC may be configured for Ethernet and PLC communication only, while another MCC may be configured for Ethernet and Bluetooth communication only, while yet another MCC may be configured for wireless, Bluetooth, and PLC communication. Any permutation or combination of communication means may be provided for on any specific MCC without departing from the scope of this disclosure. Embodiments without the capability of at least one communications means may be termed a “limited CC”. Multiple differently limited CCs, for example, one that is limited to Bluetooth and PLC, and one limited to Bluetooth and Wi-Fi, may communicate together via their shared communication protocol. In such an example the Bluetooth and PLC limited MCC may relay its digital impression to a remote server by using its shared communication protocol (in this case Bluetooth) to relay information to the other CC, which may then transmit both its digital impression and the digital impression received from the other limited MCC to the remote server via Wi-Fi.

In embodiments, a single MCC may be configured to use any and all suitable communications means.

Multiple CCs may be networked together via suitable communications networks. Multiple CCs in a particular physical location may be considered a “node”. Multiple nodes may be connected together to form a network or MCC network. In embodiments, a single node may constitute a network or MCC network.

The CCs in a node may transmit and receive communications with one another in order to determine which of the CCs has the strongest connection to a communication network capable of transmitting information to a target device external to the node. The other CCs of the node may then relay information to the target device through the MCC with said strongest connection. The MCC through which the node's information is relayed may update in the event that the connection strength changes. This may allow all of the CCs in the node to be able to communicate with the remote device even if any particular MCC cannot directly communicate with said remote device. Furthermore, this relaying of information between networked CCs does not have to be direct, and may be indirect. For example, a first MCC may transmit information to a second CC, which may, in turn, transmit the information from the first MCC to a third CC, that may then transmit the information from the first MCC to a remote device. This ability to relay information through a series of networked CCs may also provide for a “gap jumping” ability, where an MCC that is not capable of transmitting directly to a remote device may relay information through one or a series of connected CCs until one of them is able to establish a connection to the remote device.

This relaying of information between networked CCs does not have to be direct, and may be indirect. In embodiments, a plurality of CCs constituting a node may be connected together in a mesh network configuration. Such a mesh network of CCs, for example, may relay information using either a flooding technique or a routing technique. To ensure all its paths' availability, the network may allow for continuous connections and should be able to reconfigure itself around broken paths, using self-healing algorithms. Self-healing allows a routing-based network to operate when a node breaks down or when a connection becomes unreliable. Utilizing such a mesh network configuration, a first MCC may transmit information to a second CC, which may in turn transmit the information from the first MCC to a third CC, that may then transmit the information from the first MCC to a remote device. This ability to relay information through a series of networked CCs may also provide for a “gap jumping” ability, where an MCC that is not capable of transmitting directly to a remote device may relay information through one or a series of connected CCs until one of them is able to establish a connection to the remote device.

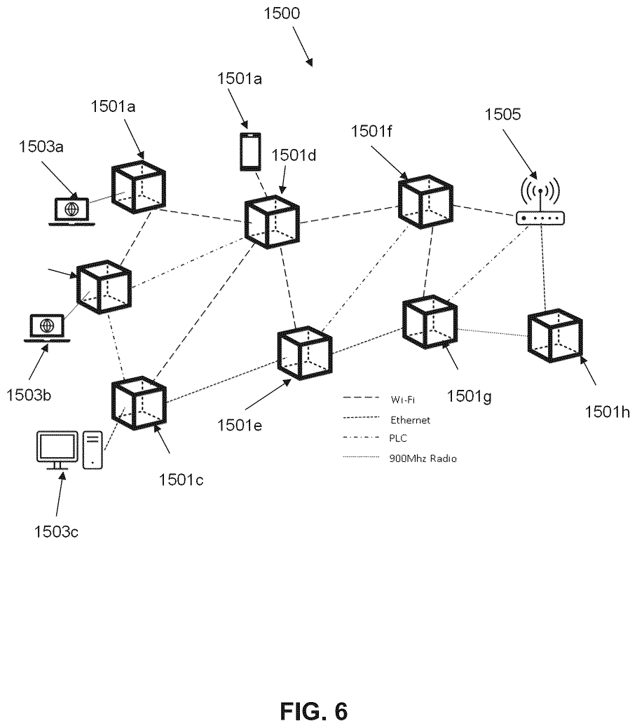

FIG. 6 is a diagram illustrating a network environment 1500 for purposes of describing a self-healing network embodiment. This network environment 1500 may correspond to a node mentioned above. For purposes of example, let us assume that the network environment 1500 comprises a plurality of CCs 1501a-1501h in an office building that are interconnected in a mesh network configuration. Each CC may be connected to one or more networked electronic devices 1503, such as computers, printers, cellular telephones, alarm system nodes, Wi-Fi routers, security cameras, digital temperature sensors (i.e., thermometers) and other environmental sensors, servers, and any other type of networkable electronic devices that might typically be found in an office building. In order not to obfuscate the drawing and the ensuing discussion, FIG. 6 shows only four of the electronic devices, namely, a first computer 1503a coupled to CC 1501a, a second computer 1503b coupled to CC 1501b, a server 1503c coupled to CC 1501c, and a smart phone 1503d coupled to CC 1501d. Each CC 1501 is able to communicate with at least one other CC, and, in most cases, with multiple other CCs, as shown, thereby forming a mesh network through which the electronic devices 1503 (as well as the CCs 1501) can communicate with each other and exchange data as needed. Each line (or edge) between any two CCs represents a direct communication path between those two CCs (hereinafter sometimes referred to as a “link”). As previously discussed, the various links may be of different communication modes. For example, in FIG. 6, the solid lines represent Digi 900 Mhz wireless communication links, the dot/dashed lines represent power line communication (PLC) links, the dashed lines represent Wi-Fi links, and the dotted lines represent Ethernet wired links.

Furthermore, as previously discussed, each CC 1501 may have more than one communication link with any other CC. For instance, CC 1501a may have an Ethernet link, a Wi-Fi link, and a PLC link with CC 1501b. However, again, for sake of not obfuscating the drawing, only one communication link per pair of CCs is assumed and shown in FIG. 6. Each CC may have a unique MAC address per communication mode. Thus, a CC that, for example, has Wi-Fi 2.4 GHz capabilities, Wi-Fi 5.2 GHz capabilities, Ethernet capabilities, and PLC capabilities would have four MAC addresses.

In this example, the network environment 1500 also includes a gateway 1505 that connects the network environment to the outside world, e.g., to the Internet, so that the devices 1503 and CCs 1501 can communicate with resources outside of the network environment in the building.

In an example, if computer 1503a needs to send data to a remote location outside of the network environment 1500, it would do so via the gateway 1505, which is a connection to outside world (e.g., the Internet). Thus, computer 1503a transmits the data to CC 1501a, which needs to transmit that data to the gateway 1505. However, CC 1501a does not have a direct connection to the gateway 1505. Thus, it must send the data to gateway 1505 via one or more other CCs 1501 in the network environment. As can be seen in FIG. 6, there are many options for transmitting the data from CC 1501a to gateway 1505. Merely as a few examples, in one case, the data can be transmitted from CC 1501a through CC 1501b, CC 1501c, CC 1501d, and 1501f to gateway 1505. This would comprise a total of five hops from the source CC 1501a to the gateway 1505. Alternately, it could be transmitted from CC 1501a through CC 1501e, and CC 1501f to gateway 1505. This route would comprise only three hops from source CC 1501a to gateway 1505. Many other routes also are available. Also, in certain cases, the network environment may have two or more gateways that connect to the internet, thereby providing an even greater variety of routes through the network environment to any given remote destination (as it would likely have multiple potential routes through the network environment to each of the gateways).

A routing algorithm through the mesh network should be selected to optimize the use of the network resources. U.S. patent application Ser. No. 17/484,592 filed Sep. 24, 2021, entitled METHODS, SYSTEMS, AND APPARATUS FOR ROUTING DATA IN A SELF-HEALING NETWORK AND FOR SELF-HEALING OF A NETWORK, which is incorporated herein in its entirety by reference, discloses suitable routing algorithms for such a system. In embodiments, a plurality of CCs may cooperate to identify and share digital impression information regarding network routers and network security devices, such as network security packet sniffers, of a secured network for evading detection by the secured network routers and network security devices while identifying, monitoring, interacting with, and controlling devices on the secured network. The plurality of CCs may establish and communicate over a separate mesh communications network, or over any other network accessible to the plurality of CCs. In embodiments, where the plurality of CCs may have developed and shared, or may have received from a remote server, digital impression information regarding network routers and network security devices at an established or acceptable confidence level, one or more of the plurality of CCs may communicate over a separate mesh network established between the plurality of CCs, and/or may communicate over the secured network according to protocols that are unidentifiable or undetectable by the secured network routers and network security devices so as to remain “dark” and undetected. In embodiments, one or more of the plurality of CCs may also communicate over the secured network according to protocols that are compatible, identifiable, or detectable by the secured network routers and network security devices so as to spoof or simulate other devices known to be on the network, or that might belong on the network, to misinform the secured network routers and network security devices regarding the security or unsecured status of the secured network, and/or also to misinform network security devices regarding operations and operating status of devices identifiable, or known, by the CCs. It will be understood that the term “devices” may include firmware and software associated with hardware devices or nodes.

In embodiments, CCs may automatically assign themselves identifiers. Automatic identification of the CCs may be performed, for example, in accordance with a 6LoPan protocol. A plurality of networked CCs may automatically share digital impression information for devices detectable by, or known to, any of the plurality of CCs, and automatically share instructions for monitoring, interacting with, and controlling such devices.

In embodiments, the manner in which the MCC may be able to control the devices on its circuit vary depending on the device. For power modulation where there may no digital management capability, for example, for incandescent light bulb or older TVs, the only options may be off/on and dim up/dim down. Those “commands” are managed through increasing or decreasing the voltage and/or current being transmitted to the device being controlled through the powerline. The MCC may effectuate such a modulation of voltage and/or current through the use of a series of circuits, or through a series of resistors/transistors if analog. For other devices, which may be controlled wirelessly, the MCC may provide control signals to the device through a suitable wireless communication means (e.g., Wi-Fi, Bluetooth, IR, etc.) rather than through modulation of the waveform of the power line into which the device is connected. For example, The MCC may identify a smart TV through the power line and identify it as a TV, and may then implement a control profile identified as usable via Wi-Fi or IR. The preference of control methodology for the specific device may associated with the unique device once it is identified. The preferred control means may be limited by the communications capabilities of the MCC that is trying to control the device.

Generally, not all electrical circuits in a building are connected. Even circuits within the same breaker panel are often not directly connected. Whether it is for meeting code requirements, load limit restrictions, security, redundancy, reduction of single point failure, or convenience, multiple distinct electrical circuits are used. Addressing these hurdles when implementing a network is an additional advantage of the MCC over current technologies. Multiple CC's can be networked together to create a mesh network spanning large open areas. Multiple CC's can also be connected to communicate along that circuit over great distances and through physical barriers like floors, walls, and ceilings. These CCs may be able to communicate with one another through alternate compatible communications means or subsystems if one such means of communication is not available. For example, if two CCs both have Wi-Fi functionality and are within Wi-Fi range of one another, but are not connected to the same powerline circuit, the two CC's may communicate through the Wi-Fi network (or indirectly through the MCC mesh network) rather than communicating via PLC. Since all CCs in proximity are able to communicate as programmed (meeting designated network security requirements), either wirelessly, wired, or both, a network of CC's can “jump” significant distances between electrical circuits, through physical barriers like floors and walls where wireless signals would not otherwise penetrate via powerline, or through electromagnetic barriers, via a wireless and/or wired mesh network. It will be understood that electromagnetic barriers may include, for example, a Faraday cage electromagnetic barrier.

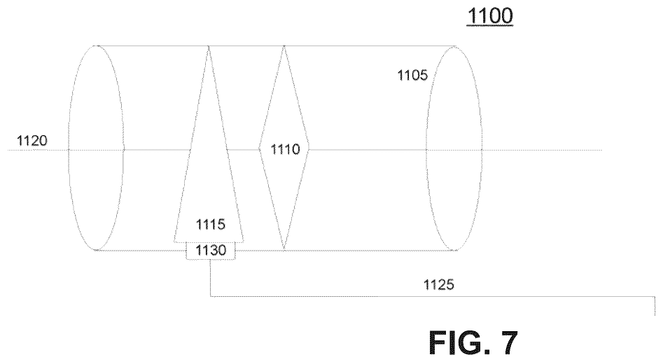

As shown in FIG. 7, a multifunction communication cube (MCC) may be connected or spliced into an electrical circuit without interrupting the downstream power flow of the circuit through use of a specially designed clamp. Referring to FIG. 7, clamp 1100 may be an insulated tube 1105 that has a single, non-conductive (glass, ceramic, etc.) blade 1110. In some embodiments, clamp 1100 may include a conductive blade 1115 that may be narrower at the top than at the bottom, and made of a conductive material (copper at minimum) and a contact pad 1130 connected to the top of the conductive blade via solder, wire etc. The contact pad 1130 allows for current to flow from the inside of the insulated tube 1105 to the outside of the insulated tube 1105. The contact pads 1130 have a wire connector 1125 that may transfer power from the insulated tube 1105 to an external device (not shown). It will be understood that this design accommodates a single wire 1120 conductor.

U.S. Pat. No. 11,102,115, which is incorporated herein by reference in its entirety, discloses additional methods, apparatus, and embodiments for connecting a communication cube into an electrical circuit without interrupting the downstream power flow.

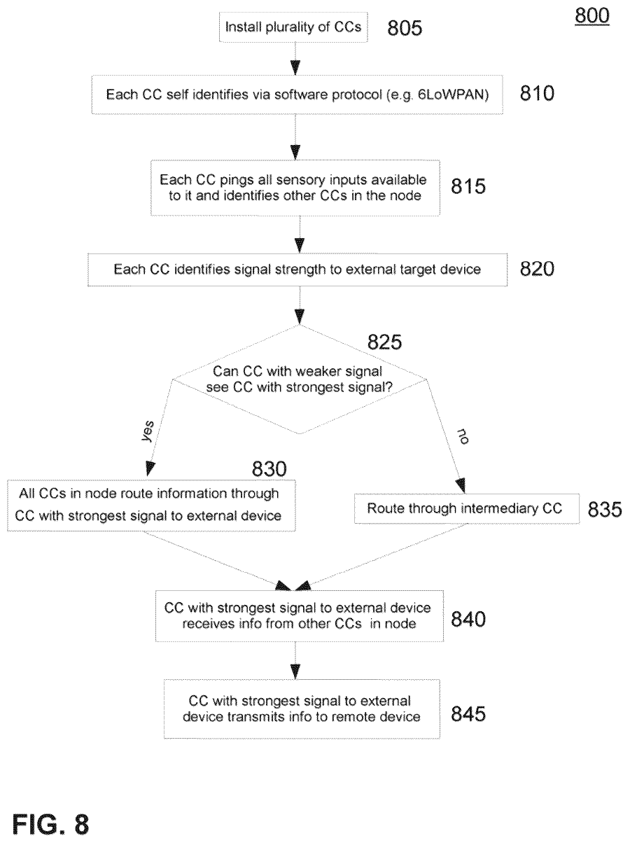

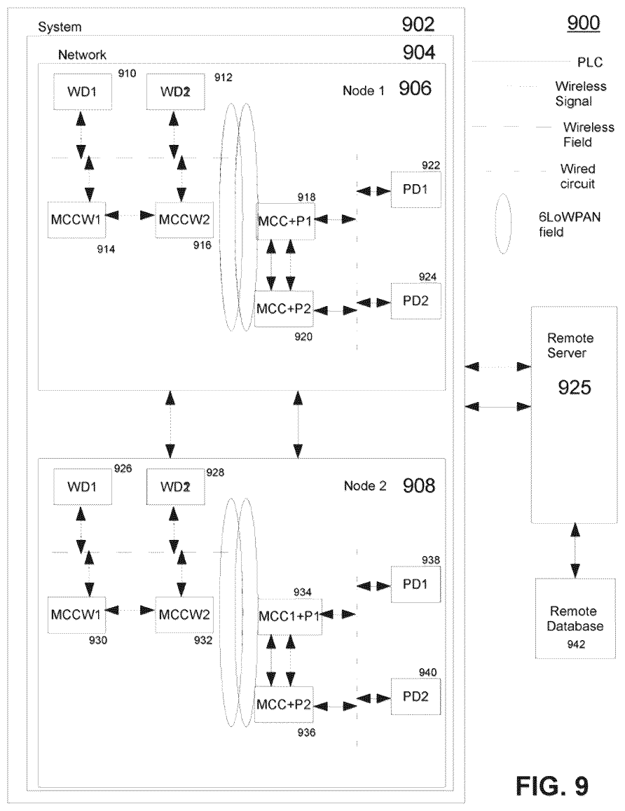

Referring to FIG. 8, in an embodiment disclosed subject matter includes method 800 for identification, communication, monitoring, and control of electronic devices at a site or node. Method 800 may include installing 805 a plurality of multifunction communication cubes (CC's) at the site or node. It will be understood that each multifunction communication cube (CC) may have a construction, features and functionality as described elsewhere in this application. A site may include, for example, at least one subject wired circuit, at least one subject wireless communication channel, or both, connected to at least one subject electronic device. Method 800 may include self-identifying 810 by each MCC via a self-identification protocol. A suitable self-identification protocol may be embodied in processor accessible code, such as software code. In an embodiment, a suitable self-identification protocol is 6LowPan. Method 800 may include pinging 815 by each MCC all sensory inputs, including available communications inputs, to identify all other CCs in the node. Method 800 may include identifying 820 by each MCC signal strength to an external target device such as, for example, a wireless network access point or wireless communications transceiver, for communication to a remote server over an external communications network such as, for example, the Internet. It will be understood that a suitable wireless communications transceiver may include a transceiver of a wireless mobile data network or cellular communications network. Method 800 may include identifying 820 signal strengths from each MCC to an external target device. Method 800 may include determining 825 whether each MCC having a relatively weaker signal strength to an external target device can see and enter into communications with another MCC having relatively strongest signal strength to an external target device. Method 800 may include direct routing 830 of information by all CCs in the node through an MCC identified as having the relatively strongest signal strength to an external target device. Method 800 may include indirect routing 835 of information by any CCs in the node to an intermediary MCC and from the intermediary MCC through an MCC identified as having the relatively strongest signal strength to an external target device. Method 800 may include receiving 840 information by an MCC identified as having the relatively strongest signal strength to an external target device, from other CCs in the node. Method 800 may include transmitting 845 information by the MCC identified as having the relatively strongest signal strength to an external target device, to said external target device. It will be understood that the particular MCC identified as having relatively strongest signal strength to an external target device may change from time to time as conditions at the site change, or as external target devices such as external wireless infrastructure changes. It will be understood that method 800 may be performed by any suitable system such as, for example, system 900 shown in FIG. 9.

Referring to FIG. 9, in an embodiment disclosed subject matter includes system 900 for identification, communication, monitoring, and control of electronic devices at a site. System 900 may include a first node 906 and second node 908 at the site. The first node 906 and second node 908 may be identical, except that each node may be connected to different infrastructure at the site and/or each node may include different sets or groups of multifunction communication cubes (MCCs). The first node 906 is exemplary and will be described in further detail. First node 906 may include a plurality of MCCs (914, 916, 918, 920) at the site. It will be understood that each multifunction communication cube (914, 916, 918, 920) may include all, or a subset, of the same or similar components, features, and functionality of apparatus 100, apparatus 200, and apparatus 300 described in detail elsewhere in this application. In the particular embodiment shown in FIG. 9, the MCCs are more specifically characterized by reference to such devices including wireless communications subsystems (MCCW1, MCCW2), and other such devices including both wireless communications subsystems and wired or powerline connections (designated MCCW+P1, MCCW+P2). First node 906 may include, for example, multifunction communication cubes (MCCs designated MCCW+P1, MCCW+P2) connected to a subject wired circuit having at least one subject wired device (PD1, PD2) connected thereto. A subject circuit may be, for example, an electrical circuit of a building to provide power to electronic devices, or any other suitable circuit such as a wired Ethernet connection of such a building. As shown in FIG. 9, each MCC may be connected to at least one conductor of the subject circuit via a clamp as described elsewhere and shown in FIG. 7, or may be otherwise connected or installed in conductive relationship with at least one conductor or wire of the subject circuit. First node 906 may include, for example, multifunction communication cubes (MCCs designated MCCW1, MCCW2, MCCW+P1, MCCW+P2) each connected to subject wireless communication channels and providing wireless connections to each subject wireless electronic device (WD1, WD2) within wireless reception and transmission range of such multifunction communication cubes (MCCs designated MCCW1, MCCW2, MCCW+P1, MCCW+P2). A subject wireless communication channel may be, for example, a ZigBee, XBee, Wi-Fi or Bluetooth wireless communication channel or infrastructure associated with the building or structure at the site, associated with a network at the site, or associated with subject wireless electronic devices present at the site. Each MCC may ping over all available inputs (P1, P2) of the MCC to a subject wired circuit to subject wired devices (PD1, PD2) and to subject wireless communications channels to subject wireless devices (WD1, WD2). The plurality of multifunction communication cubes (MCCs designated MCCW1, MCCW2, MCCW+P1, MCCW+P2) each may also include suitable wireless communication subsystems, such as 6LoWPAN subsystems, providing wireless communication channels and enabling wireless connections with each other multifunction communication cube (MCCs designated MCCW1, MCCW2, MCCW+P1, MCCW+P2) within wireless reception and transmission range of such multifunction communication cubes (MCCs designated MCCW1, MCCW2, MCCW+P1, MCCW+P2). Each of the multifunction communication cubes (MCCs designated MCCW1, MCCW2, MCCW+P1, MCCW+P2) may receive device signal information, signal noise, and/or conflated device signals via available inputs of the MCC from the respective subject circuits and subject wireless communications channels. Each of the multifunction communication cubes (MCCs designated MCCW1, MCCW2, MCCW+P1, MCCW+P2) may aggregate by an MCC local processor device signal information, signal noise and/or conflated device signals recorded from each of the inputs of the CC, to generate an aggregated digital impression or multidimensional digital impression information including recorded signal noise and recorded wireless communications information. Each of the multifunction communication cubes (MCCs designated MCCW1, MCCW2, MCCW+P1, MCCW+P2) may perform disambiguation determining or analyzing of constituent unique device waveforms in recorded device signal information, signal noise and/or conflated device signals, by the local processor of the MCC comparing the recorded device signal information, signal noise and/or conflated device signals with samples of known unique device waveforms of known devices and/or devices previously or contemporaneously identified at the site, which are stored in MCC memory and/or stored in a local database of the MCC or any MCC in communication with the subject MCC at the site. Each of the multifunction communication cubes (MCCs designated MCCW1, MCCW2, MCCW+P1, MCCW+P2) may perform local identifying of devices from the aggregated digital impression information by the MCC. Each of the multifunction communication cubes (MCCs designated MCCW1, MCCW2, MCCW+P1, MCCW+P2) may perform transmitting of aggregated digital impression information from the MCC to a remote device, such as a remote server 925, via a connection to an external communications network. It will be understood that, for example, the remote server 925 may be accessed over the Internet. Remote server 925 may perform remote disambiguation determining or analyzing of aggregated digital impression or multidimensional digital impression information including recorded signal noise and recorded wireless communications information to identify constituent unique device waveforms in recorded device signal information, signal noise and/or conflated device signals, and to identify constituent device wireless communications properties or wireless constituent device identification information, by a remote processor of the remote server 925 comparing the recorded device signal information, signal noise and/or conflated device signals with samples of known unique device waveforms of known devices and/or devices previously or contemporaneously identified at the site, and comparing recorded wireless communications information with known wireless communications information or properties of known devices or device types to identify constituent device wireless communications properties or wireless constituent device unique identification information, which are stored in memory (not shown) associated with the remote server and/or stored in a remote database (not shown). It will be understood that one suitable database of known devices and device waveforms and identification information may be, for example, the MIT Project Dilon signal fingerprint database. Remote server 925 may perform analyzing to identify devices connected to a subject circuit or capable of communicating over a subject wireless communication channel or wireless infrastructure at the site, by identifying unique device waveforms of known devices that produce same, or identifying device wireless communications information or properties of known devices, from the remote database. Remote server 925 may transmit identification information of devices from the remote server over a suitable communications network to the multifunction communication cubes (MCCs designated MCCW1, MCCW2, MCCW+P1, MCCW+P2). Each of the multifunction communication cubes (MCCs designated MCCW1, MCCW2, MCCW+P1, MCCW+P2) may perform associating of device control pathways, such as command signals, with each identified device connected to a subject circuit connected to a multifunction communication cube (MCCs designated MCCW1, MCCW2, MCCW+P1, MCCW+P2) or visible over a wireless communications connection or channel to a multifunction communication cubes (MCCs designated MCCW1, MCCW2, MCCW+P1, MCCW+P2), by a processor of the same. It will be understood that command signals of devices may be obtained from local memory of the multifunction communication cubes (MCCs designated MCCW1, MCCW2, MCCW+P1, MCCW+P2). Multifunction communication cubes (MCCs designated MCCW1, MCCW2, MCCW+P1, MCCW+P2) by the local MCC processor may generate or transmit command signals or control signals associated with identified devices connected to the subject circuit, and/or over a wireless communications connection or channel, to interact with and control aspects of such identified devices. It will be understood that, in some embodiments, command signals or control signals may be communicated to such identified devices over a wireless connection to an identified device, via a suitable wireless subsystem of the multifunction communication cubes (MCCs designated MCCW1, MCCW2, MCCW+P1, MCCW+P2). It will be understood that the first node 906 and second node 908 may communicate and share information regarding wired electronic devices (PD1, PD2) and wireless devices (WD1, WD2).

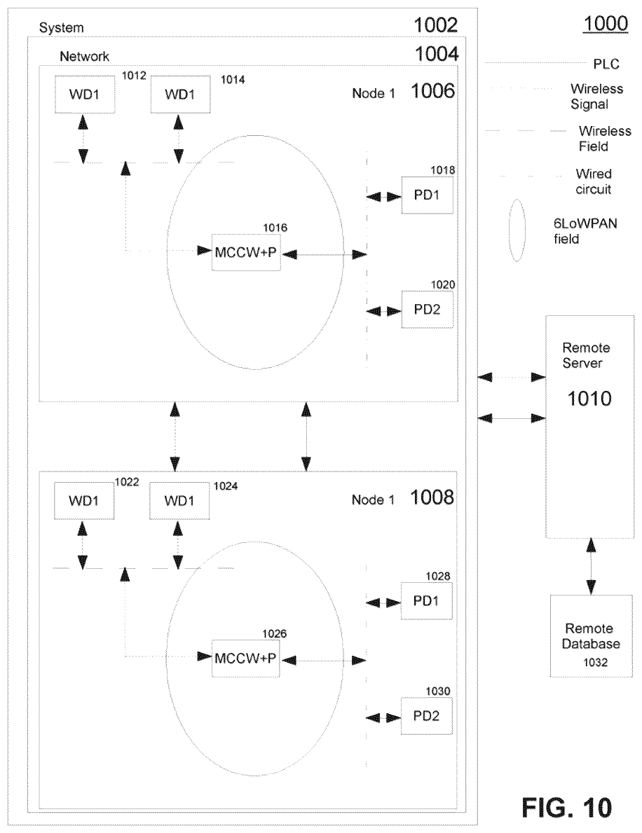

FIG. 10 illustrates a system 1000 including network 1004 having a first node 1006 and second node 1008. Each of the first node 1006 and second node 1008 include a respective single multifunction communication cube (MCC) (1016, 1026) having wireless and wired communications capabilities and subsystems. System 1000 may be otherwise identical, or substantially similar, to system 900 illustrated in FIG. 9.

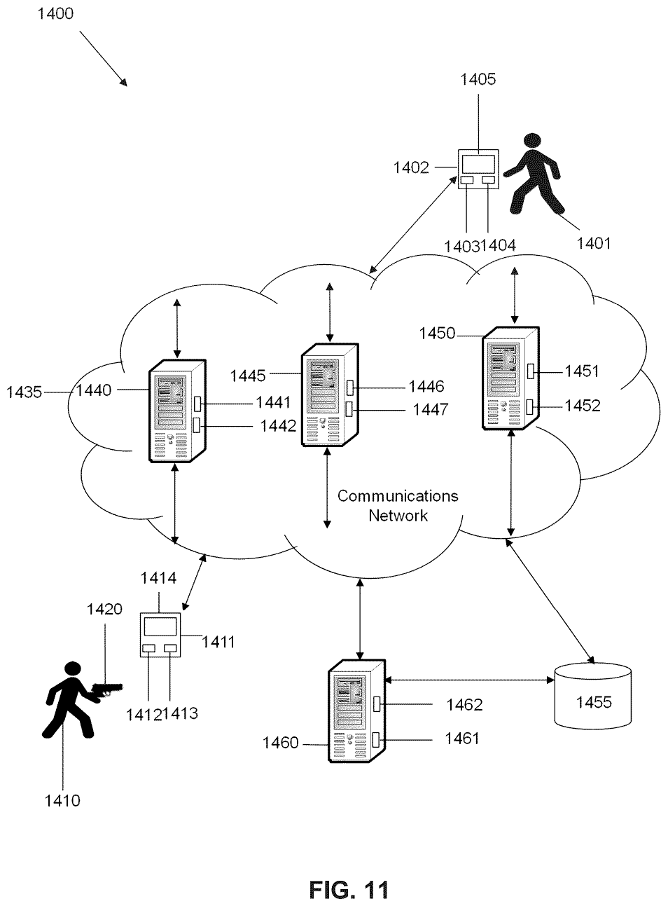

Referring now also to FIG. 11, the systems illustrated in any of the previously discussed Figures may also be configured to operate with system 1400. The system 1400 may be configured to couple with the systems in those Figures, interact with the systems in those Figures, facilitate the operative functionality of the systems in those Figures, and/or conduct any of the functionality described in the present disclosure. Notably, the system 1400 may be configured to support, but is not limited to supporting, monitoring systems and services, data analytics systems and services, artificial intelligence services and systems, machine learning services and systems, content delivery services, cloud computing services, satellite services, telephone services, voice-over-internet protocol services (VoIP), software as a service (SaaS) applications, platform as a service (PaaS) applications, gaming applications and services, social media applications and services, operations management applications and services, productivity applications and services, mobile applications and services, and/or any other computing applications and services. Notably, the system 1400 may include a first user 1401, who may utilize a first user device 1402 to access data, content, and services, or to perform a variety of other tasks and functions. As an example, the first user 1401 may utilize first user device 1402 to transmit signals to access various online services and content, such as those available on an internet, on other devices, and/or on various computing systems. As another example, the first user device 1402 may be utilized to access an application that provides any or all of the operative functions of the system 1400. In certain embodiments, the first user 1401 may be a bystander, any type of person, a robot, a humanoid, a program, a computer, any type of user, or a combination thereof, that may be located in a particular environment. The first user device 1402 may include a memory 1403 that includes instructions, and a processor 1404 that executes the instructions from the memory 1403 to perform the various operations that are performed by the first user device 1402. In certain embodiments, the processor 1404 may be hardware, software, or a combination thereof. The first user device 1402 may also include an interface 1405 (e.g., screen, monitor, graphical user interface, etc.) that may enable the first user 1401 to interact with various applications executing on the first user device 1402 and to interact with the system 1400. In certain embodiments, the first user device 1402 may be and/or may include a computer, any type of sensor, a laptop, a set-top-box, a tablet device, a phablet, a server, a mobile device, a smartphone, a smart watch, and/or any other type of computing device. Illustratively, the first user device 1402 is shown as a smartphone device in FIG. 11. In certain embodiments, the first user device 1402 may be utilized by the first user 1401 to control and/or provide some or all of the operative functionality of the system 1400.

In addition to using first user device 1402, the first user 1401 may also utilize and/or have access to additional user devices. As with first user device 1402, the first user 1401 may utilize the additional user devices to transmit signals to access various online services and content. The additional user devices may include memories that include instructions, and processors that execute the instructions from the memories to perform the various operations that are performed by the additional user devices. In certain embodiments, the processors of the additional user devices may be hardware, software, or a combination thereof. The additional user devices may also include interfaces that may enable the first user 1401 to interact with various applications executing on the additional user devices and to interact with the system 1400. In certain embodiments, the first user device 1402 and/or the additional user devices may be and/or may include a computer, any type of sensor, a laptop, a set-top-box, a tablet device, a phablet, a server, a mobile device, a smartphone, a smart watch, and/or any other type of computing device, and/or any combination thereof. Sensors may include, but are not limited to, motion sensors, pressure sensors, temperature sensors, light sensors, heart-rate sensors, blood pressure sensors, sweat detection sensors, breath-detection sensors, stress-detection sensors, any type of health sensor, humidity sensors, any type of sensors, or a combination thereof. The sensors for the first user device 1402 may communicate with the sensors of any of the communication cubes as disclosed in the present disclosure.

The first user device 1402 and/or additional user devices may belong to and/or form a communications network. In certain embodiments, the communications network may be a local, mesh, or other network that enables and/or facilitates various aspects of the functionality of the system 1400. In certain embodiments, the communications network may be formed between the first user device 1402 and additional user devices through the use of any type of wireless or other protocol and/or technology. For example, user devices may communicate with one another in the communications network by utilizing any protocol and/or wireless technology, satellite, fiber, or any combination thereof. Notably, the communications network may be configured to communicatively link with and/or communicate with any other network of the system 1400 and/or outside the system 1400. In certain embodiments, the first user device 1402 and/or additional user device may form a mesh network with the communication cubes described in the present disclosure.

In addition to the first user 1401, the system 1400 may also include a second user 1410. The second user device 1411 may be utilized by the second user 1410 (or even potentially the first user 1401) to transmit signals to request various types of content, services, and data provided by and/or accessible by communications network 1435 or any other network in the system 1400. In further embodiments, the second user 1410 may be a robot, a computer, a humanoid, an animal, any type of user, or any combination thereof. The second user device 1411 may include a memory 1412 that includes instructions, and a processor 1413 that executes the instructions from the memory 1412 to perform the various operations that are performed by the second user device 1411. In certain embodiments, the processor 1413 may be hardware, software, or a combination thereof. The second user device 1411 may also include an interface 1414 (e.g., screen, monitor, graphical user interface, etc.) that may enable the first user 1401 to interact with various applications executing on the second user device 1411 and to interact with the system 1400. In certain embodiments, the second user device 1411 may be a computer, a laptop, a set-top-box, a tablet device, a phablet, a server, a mobile device, a smartphone, a smart watch, and/or any other type of computing device. Illustratively, the second user device 1411 is shown as a mobile device in FIG. 11. In certain embodiments, the second user device 1411 may also include sensors, such as, but are not limited to, motion sensors, pressure sensors, temperature sensors, light sensors, heart-rate sensors, blood pressure sensors, sweat detection sensors, breath-detection sensors, stress-detection sensors, any type of health sensor, humidity sensors, any type of sensors, or a combination thereof.

The system 1400 may also include a communications network 1435. The communications network 1435 may be under the control of a service provider, the first user 1401, the second user 1410, any other designated user, a computer, another network, or a combination thereof. The communications network 1435 of the system 1400 may be configured to link each of the devices in the system 1400 to one another. For example, the communications network 1435 may be utilized by the first user device 1402 to connect with other devices within or outside communications network 1435. Additionally, the communications network 1435 may be configured to transmit, generate, and receive any information and data traversing the system 1400. In certain embodiments, the communications network 1435 may include any number of servers, databases, or other componentry. The communications network 1435 may also include and be connected to a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 1440, 1445, and 1450 are shown as being included within communications network 1435. In certain embodiments, the communications network 1435 may be part of a single autonomous system that is located in a particular geographic region, or be part of multiple autonomous systems that span several geographic regions.

Notably, the functionality of the system 1400 may be supported and executed by using any combination of the servers 1440, 1445, 1450, and 1460. The servers 1440, 1445, and 1450 may reside in communications network 1435, however, in certain embodiments, the servers 1440, 1445, 1450 may reside outside communications network 1435. The servers 1440, 1445, and 1450 may provide and serve as a server service that performs the various operations and functions provided by the system 1400. In certain embodiments, the server 1440 may include a memory 1441 that includes instructions, and a processor 1442 that executes the instructions from the memory 1441 to perform various operations that are performed by the server 1440. The processor 1442 may be hardware, software, or a combination thereof. Similarly, the server 1445 may include a memory 1446 that includes instructions, and a processor 1447 that executes the instructions from the memory 1446 to perform the various operations that are performed by the server 145. Furthermore, the server 150 may include a memory 1451 that includes instructions, and a processor 1452 that executes the instructions from the memory 1451 to perform the various operations that are performed by the server 1450. In certain embodiments, the servers 1440, 1445, 1450, and 1460 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 1440, 1445, 1450 may be communicatively linked to the communications network 1435, any network, any device in the system 1400, or any combination thereof.

The database 1455 of the system 1400 may be utilized to store and relay information that traverses the system 1400, cache content that traverses the system 1400, store data about each of the devices in the system 1400 and perform any other typical functions of a database. In certain embodiments, the database 1455 may be connected to or reside within the communications network 1435, any other network, or a combination thereof. In certain embodiments, the database 1455 may serve as a central repository for any information associated with any of the devices and information associated with the system 1400. Furthermore, the database 1455 may include a processor and memory or be connected to a processor and memory to perform the various operation associated with the database 1455. In certain embodiments, the database 1455 may be connected to the servers 1440, 1445, 1450, 1460, the first user device 1402, the second user device 1411, the additional user devices, any devices in the system 1400, any process of the system 1400, any program of the system 1400, any other device, any network, or any combination thereof.

The database 1455 may also store information and metadata obtained from the system 1400, store metadata and other information associated with the first and second users 1401, 1410, store communications traversing the system 1400, store user preferences, store information associated with any device or signal in the system 1400, store information relating to patterns of usage relating to the user devices 1402, 1411, store any information obtained from any of the networks in the system 1400, store historical data associated with the first and second users 1401, 1410, store device characteristics, store information relating to any devices associated with the first and second users 1401, 1410, store information associated with the communications network 1435, store any information generated and/or processed by the system 1400, store any of the information disclosed for any of the operations and functions disclosed for the system 1400 herewith, store any information traversing the system 1400, or any combination thereof. Furthermore, the database 1455 may be configured to process queries sent to it by any device in the system 1400.

Notably, as shown in FIG. 11, the system 1400 may perform any of the operative functions disclosed herein by utilizing the processing capabilities of server 1460, the storage capacity of the database 1455, or any other component of the system 1400 to perform the operative functions disclosed herein. The server 1460 may include one or more processors 1462 that may be configured to process any of the various functions of the system 1400. The processors 1462 may be software, hardware, or a combination of hardware and software. Additionally, the server 1460 may also include a memory 1461, which stores instructions that the processors 1462 may execute to perform various operations of the system 1400. For example, the server 1460 may assist in processing loads handled by the various devices in the system 1400, such as, but not limited to, monitoring a state of a mesh network including any number of communication cubes; monitoring the connections between communication cubes and/or other devices in the mesh network; updating routing tables indicating connection changes of the mesh network; determining that status of each communication (and/or node) in the mesh network; determining radio signal strength to a communication cube (and/or node) from a device of interest; determining data rates associated with the mesh network; determining error rates associated with the mesh network; monitoring wired connections in addition to wireless connections of the network; selecting the best performing path via the mesh network to send data to a destination; determining alternate routes within the mesh network in the event a cube and/or node fails in the mesh network; performing monitoring at selected time intervals; probing connections that each communication cube locates; building a network of connections based on MAC addresses associated with the connections; testing the speed of detected connections; testing the data rate of the mesh network; determining an accuracy of data transmitted; building tables with data on detected cubes and/or nodes; transmitting the table and/or information to a subset or all of the mesh network; building a routing table that prioritizes the fastest data for the best path to each node/cube; and performing any other suitable operations conducted in the system 100 or otherwise. In one embodiment, multiple servers 1460 may be utilized to process the functions of the system 1400. The server 1460 and other devices in the system 100, may utilize the database 1455 for storing data about the devices in the system 1400 or any other information that is associated with the system 1400. In one embodiment, multiple databases 1455 may be utilized to store data in the system 1400.

Although FIGS. 6, 11, and 12 illustrate specific example configurations of the various components of the system 1400, the system 1400 may include any configuration of the components, which may include using a greater or lesser number of the components. For example, the system 1400 is illustratively shown as including a first user device 1402, a second user device 1411, a communications network 1435, a server 1440, a server 1445, a server 1450, a server 1460, and a database 1455. However, the system 1400 may include multiple first user devices 1402, multiple second user devices 1411, multiple communications networks 1435, multiple servers 1440, multiple servers 1445, multiple servers 1450, multiple servers 1460, multiple databases 1455, or any number of any of the other components inside or outside the system 1400. Furthermore, in certain embodiments, substantial portions of the functionality and operations of the system 1400 may be performed by other networks and systems that may be connected to system 1400.

Notably, the system 1400 may execute and/or conduct the functionality as described in the method(s) disclosed herein above.

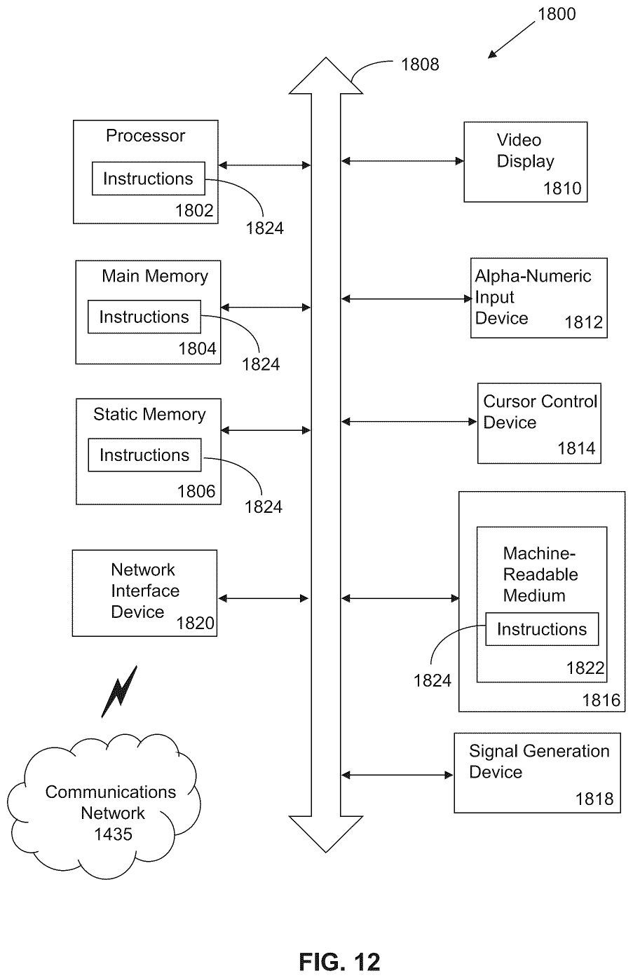

Referring now also to FIG. 12, at least a portion of the methodologies and techniques described with respect to the exemplary embodiments of the system 1800 can incorporate a machine, such as, but not limited to, computer system 1800, or other computing device within which a set of instructions, when executed, may cause the machine to perform any one or more of the methodologies or functions discussed above. The machine may be configured to facilitate various operations conducted by the system 1400. For example, the machine may be configured to, but is not limited to, assist the system 1400 by providing processing power to assist with processing loads experienced in the system 1400, by providing storage capacity for storing instructions or data traversing the system 1400, or by assisting with any other operations conducted by or within the system 1400. As another example, the computer system 1800 may assist with monitoring a mesh network of the system and/or communication cubes of the system.

In some embodiments, the machine may operate as a standalone device. In some embodiments, the machine may be connected (e.g., using communications network 1435, another network, or a combination thereof) to and assist with operations performed by other machines and systems, such as, but not limited to, the first user device 1402, the second user device 1411, the server 1440, the server 1445, the server 1450, the database 1455, the server 1460, any other system, program, and/or device, or any combination thereof. The machine may be connected with any component in the system 1400. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 1800 may include a processor 1802 (e.g., a central processing unit (CPU), a graphics processing unit (GPU, or both), a main memory 1804 and a static memory 1806, which communicate with each other via a bus 1808. The computer system 1800 may further include a video display unit 1810, which may be, but is not limited to, a liquid crystal display (LCD), a flat panel, a solid state display, or a cathode ray tube (CRT). The computer system 1800 may include an input device 1812, such as, but not limited to, a keyboard, a cursor control device 1814, such as, but not limited to, a mouse, a disk drive unit 1816, a signal generation device 1818, such as, but not limited to, a speaker or remote control, and a network interface device 1820.

The disk drive unit 1816 may include a machine-readable medium 1822 on which is stored one or more sets of instructions 1824, such as, but not limited to, software embodying any one or more of the methodologies or functions described herein, including those methods illustrated above. The instructions 1824 may also reside, completely or at least partially, within the main memory 1804, the static memory 1806, or within the processor 1802, or a combination thereof, during execution thereof by the computer system 1800. The main memory 1804 and the processor 1802 also may constitute machine-readable media.

### Alternate and Additional Features and Embodiments

1. Routing Data Over Medium and High Voltage Power Lines

In embodiments, any of the communication cubes disclosed herein above, including any of the apparatus shown in FIGS. 1-3, may be adapted to provide communication over power lines that carry voltages greater than the 120 volt or 240 volt power typically found in households and offices. These include what are known as medium and/or high voltage power lines. High voltage power lines refer to those types of power lines that are commonly used to transmit power from large scale power plants to cities, and typically carry about 100,000 to about 200,000 volts or higher. Medium voltage power lines refer to those types of power lines that are commonly used to transmit power between sub-stations in different cities, and typically carry about 1,000 volts to about 69,000 volts or higher.

When electrical power is transported over long distances, it is commonly transported at such high voltages to reduce the resistance of the physical medium (i.e., the wires). It is stepped down by a transformer to a lower, more useful voltage for local distribution. For instance, power may be transported from a power plant to a city at 100,000 to 200,000 volts over hundreds of miles with relatively little loss. Transformer stations in the city may step that voltage down by about an order of magnitude to transmission to other substations in the same or other cities. Other transformer stations in the city may step down the voltage to lower levels for transport within the city, and then yet other transformer stations will step the voltage down further for distribution into households, offices, etc.

Typically, electrical power is transmitted as an alternating current (AC) at a relatively low frequency. For instance, in the United States, almost all electrical power, including, high voltage transmission lines, medium voltage transmission lines, and local transmission lines carry AC current at 60 Hz. Transformers are electrical devices that take an input current at one voltage and output a current at a different voltage. A step-down transformer takes an input current at a relatively higher voltage and outputs an output current at a relatively lower voltage. A step-up transformer takes an input current at a relatively lower voltage and outputs an output current at a relatively higher voltage. A transformer essentially comprises two inductor coils of different sizes positioned adjacent to each other with a generally nonconductive medium (e.g., air) between them. Generally, inductors are poor transmitters of high frequency electrical signals, but are excellent transmitters of low frequency electrical signals (where direct current (DC) essentially may be considered zero frequency current). In power distribution, most transformers are step-down transformers since, in power transmission, voltage is almost always stepped down incrementally from the power plant to a city substation, to a more local substation, and ultimately to a final destination, such as a household, hospital, office, manufacturing plant, etc. Since most power distribution systems in the world transmit power at about 50 Hz or 60 Hz, transformers used in power distribution are generally designed to pass current at frequencies up to at least 60 Hz. However, such transformers generally cannot pass through electrical signals at frequencies much higher than that, such as the frequencies at which data is typically transmitted. Hence, generally, data at any reasonable frequency cannot pass through a power line transformer. Thus, data transmitted on a power line at higher frequencies cannot make it through a transformer station.

In accordance with an embodiment, in order to transmit data over power lines that include high voltage and medium voltage transformers, provision is made to intercept the data on the power line on the upstream side of any transformer and place it back on the power line on the downstream side of the transformer.

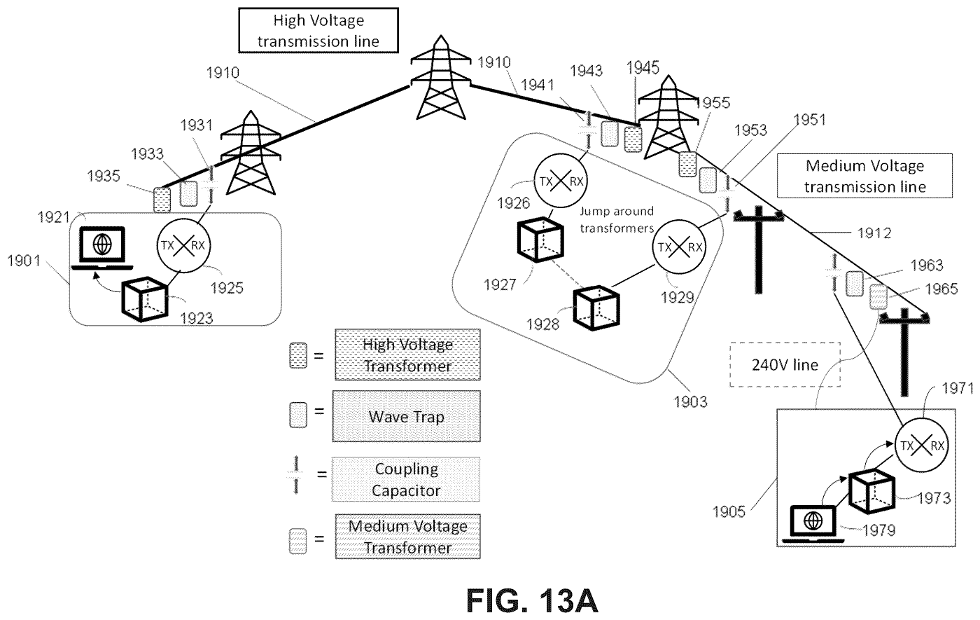

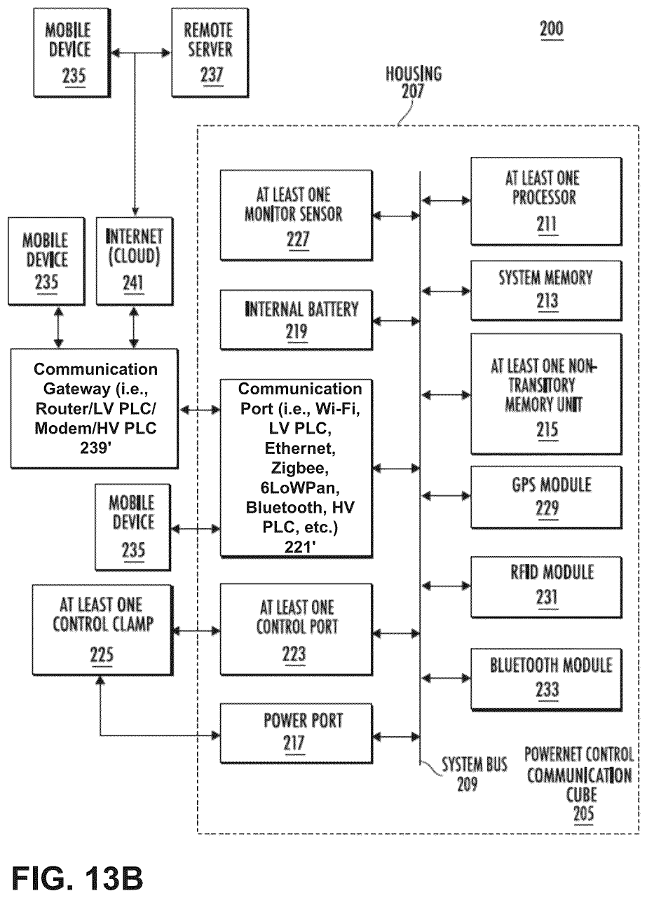

FIG. 13A is a diagram illustrating a power distribution system comprising a 138 kilovolt (kV) high voltage line 1910 that runs between a power generation plant station 1901 and a substation 1903 in a nearby city (58.8 miles away). For purposes of this discussion a substation may be considered to be a node of the power distribution system at which electrical current may be tapped off and distributed to one or more other nodes, such as other stations or substations, and/or stepped up or down in voltage (using a transformer). A substation also is a location at which data signals may be placed onto the power transmission lines and/or at which data signals on the power line may be received. Of course, many other functions may be performed at a substation, such as monitoring of the power lines, etc.

Substation 1903 may tap off and step down some of the power for further distribution within the city. FIG. 13A shows one such tap, namely, a 13.8 kV line 1912 to another substation 1905 that is 2.4 miles away from substation 1903. Typically, there may be several other taps to other substations, etc., but FIG. 13A show only one other substation and transmission line (1905, 1912, respectively) in order not to obfuscate the drawing.

A computing device, such as a personal computer (PC) 1921 is located at power station 1901 and it is desired to place data from PC 1921 onto the high voltage power line 1910 for transmission to substation 1905 via substation 1903. According to an embodiment, the PC is coupled to a network node 1923, such as any of the aforementioned communication cubes of FIGS. 1-3. In addition to the components illustrated in any of FIGS. 1-3, network node 1923 further includes a separate port and interface for coupling to a high voltage line, such as line 1910.

Using the communication cube 200 of FIG. 2 as an example, FIG. 13B shows a modified communication cube 200′ in accordance with the present embodiment. Only blocks 221 and 239 are modified relative to the device illustrated by FIG. 2. Particularly, an additional communication port for high voltage (HV) PLC is added to communication port block 221 and a corresponding gateway for high voltage (HV) power line is added to communication gateway block 239. The HV PLC communication port and the HV gateway may be identical to the original PLC communication port and gateway from FIG. 2, respectively (labelled as low voltage PLC communication port and low voltage gateway in FIG. 13B in order to distinguish from the high voltage communication port and gateway, respectively).

Network node 1923 may be a communication cube 100′ such as shown in FIG. 13B. Similar modifications may be implemented in the communication cubes of FIGS. 1 and 3.

Returning to FIG. 13A, data may be coupled from PC 1921 onto power line 1910 by transmitting the data from the PC 1921 to the network node 1923. Network node 1923 then forwards the data to a power line communication module (PLCM) 1925. PLCM 1925 is a transceiver for placing the data signals onto the power line (and/or receiving data signals from the power line). For purposes of the present discussion, it is being used as a transmitter and will be discussed as such. It may be a radio transmitter with the antenna output port connected to the power line (through a CCVT as discussed below) instead of an antenna insofar as the power line will accept the data signals just as well as an antenna. The data signals will travel down the power line rather than through the air with no or minimal actual wireless signal radiation from the power line the air. The transmitter 1925 may, for instance, comprise a 100 watt high frequency transceiver. PLCM 1925 couples to the high voltage power line 1910 through a coupling capacitor voltage transformer (CCVT) 1931. A CCVT is commonly used in power transmission for coupling data onto a power line. It has a capacitance that is high enough that it cannot pass electrical signals at low frequency, e.g., the 60 Hz frequency of the power on the high voltage power line, but can pass signals of higher frequency, e.g., the data signals from PC 1921 and network node 1923. Accordingly, CCVT 1931 passes the data signals from PLCM 1925 onto the high voltage power line 1920 but prevents any of the high voltage signal on line 1910 from feeding into the PLCM 1925, network node 1923, or PC 1921, which components are not capable of handling high voltages and would be damaged by such high voltage signals.

In addition, a wave trap 1933 is located on the power line upstream of the CCVT, wherein upstream in this context means in the direction opposite the direction in which the data signals are desired to travel and downstream means in the direction in which the data signals are desired to travel. A wave trap is a resonant circuit that prevents the higher frequency data signal from passing through it by presenting a high reactance to it. However, it allows the power signal, which is at a much lower frequency (e.g., 60 Hz) through by presenting a low reactance to low frequency signals. The wave trap permits all of the energy of the data signal to travel in the desired direction (i.e., toward substation 1905). In the absence of the wave trap 1933, half of the energy of the data signal would travel in the opposite direction on high voltage power line and be wasted energy. Thus, most of the power of the data signal travels toward destination substation 1905, rather than merely half of it.

In addition, a high voltage transformer 1935 likely would be present at the power station for transforming the high voltage on the power line 1910 to another voltage for purposes related to power transmission and use at the station. Since, as previously described, the data cannot pass through the high voltage transformer because the inductive values of transformers commonly used on power lines will filter out any portion of the frequency above a relatively low cut-off frequency threshold (usually anything above about 100 Hz), the CCVT 1931 and wave trap 1933 should be positioned on the downstream side of the transformer 1935.

Since the data signal cannot pass through a high or medium voltage transformer, at substation 1903, another CCVT 1941 is coupled to the power line 1910 before any transformer at that location. As previously discussed, CCVT 1941 allows the data signal to pass through, but blocks the lower frequency (e.g., 60 Hz) high voltage power from passing through, thereby protecting the equipment on the other side of the CCVT from the high voltage on the power line 1910. Thus, the data is extracted from the power line 1910 by CCVT 1941 and passed to a receiver 1926. Again, receiver 1926 may be a transceiver, such as a MAKE and MODEL NO., just like transceiver 1925 in power station 1902, but is being used as a receiver for purposes of the present discussion. Receiver 1926 forwards the data to a network node 1927, which may be identical to previously described network node 1923.

Meanwhile, the high voltage, low frequency power signal continues down the power line 1910 through another wave trap 1943 (which blocks any remaining energy of the high frequency data signal from passing through). On the other side of the wave trap, the power signal may be tapped off by one or more transformers 1945, 1955 for use in lower voltage power transmission and usage purposes. For instance, transformer 1945 may step down the voltage to 4 kV for local distribution in the city (not shown). Similarly, transformer 1955 also may receive the original power signal at 138 kV and step it down by a factor of ten to 13.8 kV for transmission over a medium voltage power line 1912 to substation 1905.

As previously mentioned, the data that was placed on the high voltage power line 1910 is intended for substation 1905, not this substation 1903. Accordingly, the data is not processed or otherwise used at substation 1903, but rather needs to be placed on power line 1910 for further transmission down to substation 1905. Accordingly, network node 1927 transmits the data to another network node 1928 (e.g., via a local communication network of which nodes 1927 and 1928 are a part). Network node 1928 forwards the data to a PLCM 1929, which may be identical in all practical respects to PLCM 1925 in power station 1901.

PLCM sends the signal to another CCVT 1951 to couple the data onto power line 1912. Again, a wave trap 1953 is positioned on the power line 1912 on the upstream side of the CCVT. Furthermore, for the same reasons discussed in connection with station 1901, the wave trap 1953 and CCVT 1951 are positioned on the downstream side of the high (or medium) power transformer 1955.

Accordingly, the data has passed through substation 1903 without being lost in the high voltage transformers, e.g., 1945, 1955.

The data signal and the power signal travel down power line 1912 to substation 1905, where they encounter, in order, another CCVT 1961, another wave trap 1963 and another transformer 1965. Consistent with earlier discussion, CCVT 1961 extracts the data signal from the power line 1912 and lets the medium voltage power signal pass through down the power line through wave trap 1963 and to power transformer 1965. Power transformer steps down the voltage from 13.8 kV to, for instance, 240 volts for use in powering equipment at substation 1905.

Meanwhile the data signal is passed from CCVT to another receiver 1971, which may be similar to receiver 1926 in substation 1903. Receiver 1971 passes the data to network node 1973, which may be similar to aforementioned network nodes 1923, 1927, and 1928. Since substation 1905 is the desired destination for the data, network node 1973 forwards the data to another computing device at substation 1905, such as another PC 1979.

Thus, the data generated at station 1901 has traveled through high and medium voltage power lines 1910 and 1912 and through an intermediate substation 1903 intact for use at substation 1905 and with no disruption to the power transmission down those lines.

Although not specifically discussed above, it should be understood that data also may be transmitted in the other direction between any of stations/substations 1901, 1903, and 1905. In particular, for instance, wave traps 1943 and 1963 do not serve a significant function in the above-described example in which the data signal that is being transmitted in the left to right direction in FIG. 13A (from station 1901 to substation 1905 through substation 1903) because most, if not all, of the energy of the data signal has already been extracted from the power line before it reaches those wave traps. However, if data were being transmitted in the opposite direction (e.g., from substation 1905 to station 1901 through substation 1903), then wave traps 1943 and 1963 would serve the significant function of directing all of the data signal energy in the proper direction (but wave traps 1953 and 1933 would not be serving a significant function in that scenario since most, if not all, of the data signal energy has already been removed from the line before reaching the wave traps 1953 and 1933).

2. Data Division Multiplexing

In communication networks, both user data and control data are commonly transmitted between the various nodes of the network. User data may be loosely defined as data that the users of the network exchange, such as emails, files (e.g., video files, audio files, word processing files, etc.), voice traffic (e.g., telephone calls), sensor data (e.g., a temperature sensor reporting a measured temperature to a central database), and virtually anything that one person or device might wish to send to another person or device over a communication network. Control data may be loosely defined as the signals that the network nodes send between each other to manage and control the operation of the network, and, generally comprise data that the users of the network typically do not interact with directly, but which is necessary to be exchanged between nodes of the network in order to cause the network to operate effectively. Merely a few examples of control data are mutual settings and other configurations of a first node that a second node must be aware of in order to receive and interpret data transmitted from the first node, e.g., network addressing information, modulation and coding scheme used, control signaling that is needed to cause a smooth transfer of a cellular telephone call between two cellular towers when the cellular telephone is leaving one cell and entering another cell, geo-location information, reference signals for timing and frequency alignment, measurement data (signal strength, signal to noise ratios, bit error rate), etc.

The amount of control data transmitted between nodes of a modern communication network, particularly wireless networks, is considerable. For example, in many cases, the amount of control data needed to transmit/receive a piece of user data between two nodes could be greater than the actual user data that is being transmitted/received. Furthermore, with the ever increasing number of video files, audio files, and voice calls being transmitted in modern networks, the amount of user data being transmitted/received in a typical communication network is staggering.

For instance, a single Voice over IP (VoIP) communication session between two telephones requires a minimum data rate of 300 kilobits per second (kB/s) in order to (1) allow the words spoken by the speaker to be reasonably decipherable by the person listening at the other end of the line and to keep the latency (e.g., the delay between the speaking of the sounds/words by the person at the transmitting node and the reception of the sounds/words by the person at the receiving node) short enough to permit two humans to have a reasonable conversation.

Thus, there is an ever-present march to increase the amount of data that may be transmitted over a given network by increasing the bandwidth of the network as well as increasing the efficiency with which any given piece of data can be transmitted (e.g., minimizing the amount of network resources, whether it is time, frequency, geographic space, etc. consumed to transmit a given amount of data, such as by compression encoding the data for transmission and decompression decoding at the receiver).

In accordance with an embodiment, a relatively higher data rate signal flow is split into multiple portions at a transmission node of the network, and those portions are transmitted toward a receiver node over multiple channels of a relatively lower data rate communication mode simultaneously in a multiplexed fashion, and then reassembled at the receiver node.

For example, a VoIP telephone call having a data rate of 600 kB/s may be transmitted between two communication cubes using three or four 200 kB/s channels of an XBee wireless radio.

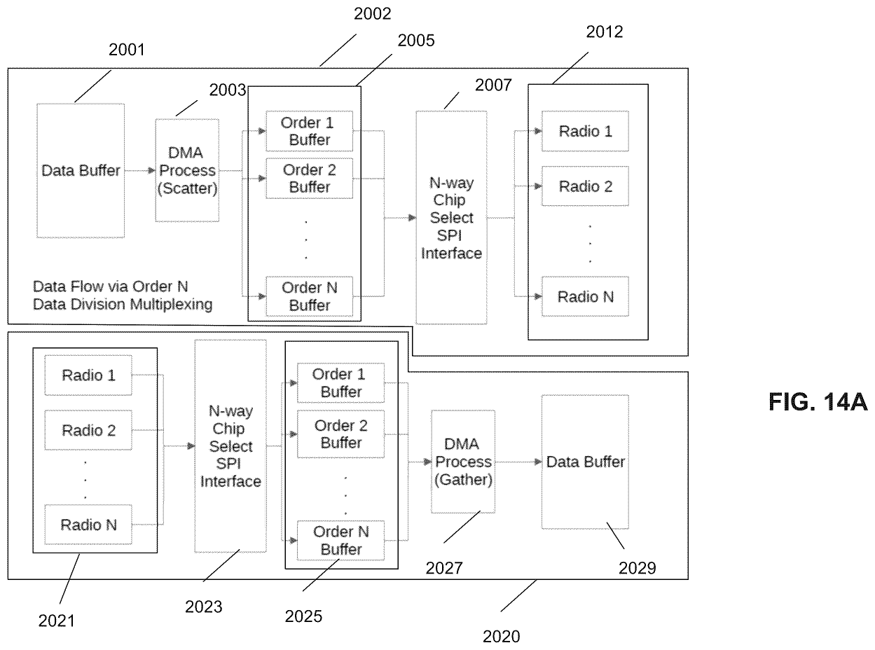

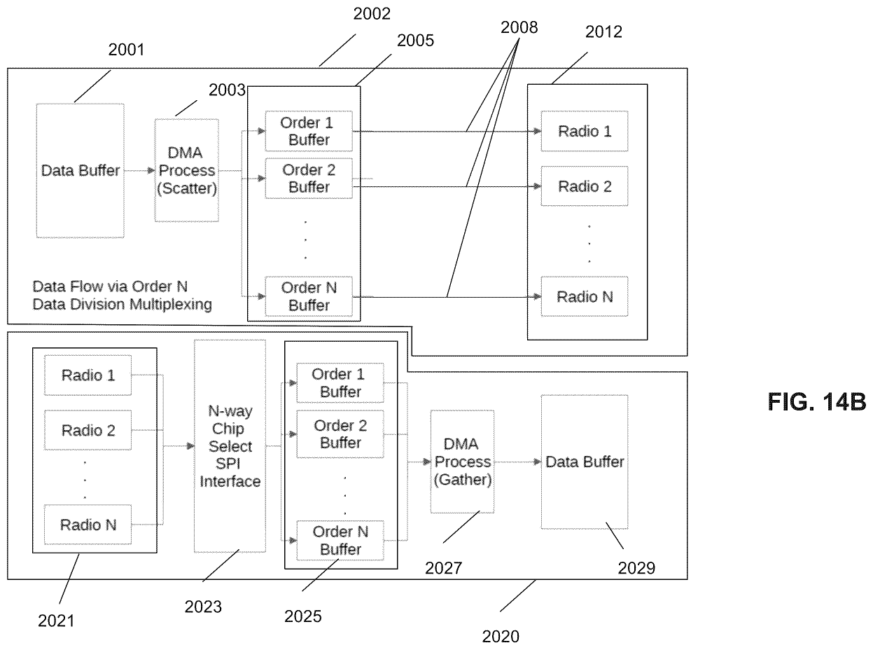

FIG. 14A is a block diagram illustrating the components for performing the above-noted data multiplexing in accordance with one exemplary embodiment. Each block in the diagram illustrates a function and/or physical component of the system. It should be apparent to those familiar with functioning of communication networks that these functions may be performed by software running on a processing device. Alternately, dedicated hardware, such as ASICs and programmable ASICs may be implemented to perform such functions. Of course, it will be understood that some of the blocks conceptually incorporate within them hardware components. For instance, it should be apparent that the radios shown in the diagram may include radios, antennas, modulators and/or demodulators, and the like.

The components illustrated in FIG. 14A may be incorporated into any network node, such as any of the communication cubes 106, 205, 305 illustrated in FIGS. 1-3, respectively. As previously discussed, a communication cube may include within it means for conducting communications via a plurality of different communication modes, such as, Ethernet, PLC, Wi-Fi, Zigbee, XBee, LoRa, 6LoWPan, Bluetooth, etc. For purposes of this exemplary embodiment, the components shown in FIG. 14A may be considered to be incorporated into each of a plurality of communication cubes forming a network (e.g., each of at least two communication cubes includes the hardware and operating software shown in FIG. 14A. Although not fully illustrated in FIG. 14A, it should be understood that each such communication cube includes all of the necessary hardware and operating software for conducting network communications in accordance with one or more relatively higher data rate communication modes, such as Ethernet, cellular, Wi-Fi, as well as hardware and operating software for conducting network communications in accordance with one or more relatively lower data rate communication modes. For instance, in the example of FIG. 14A, the radios 2012 and 2021 may each comprise an XBee radio system having N separate radio transceivers each (where N is an integer), and wherein XBee is the relatively lower bandwidth communication mode.

In order to put the exemplary embodiment in the context of a real-world application, let us consider, for example, that a plurality of communication cubes of similar construction form a mesh network in a manufacturing facility. The communication cubes are used to transmit both low data rate data, such as sensor data, using a lower data rate communication mode, such as XBee radios 2012, as well as higher data rate data, such as VoIP data and video data, using a relatively higher data rate communication mode, such as Wi-Fi. The XBee radios 2012 are well suited for transmitting the sensor data because XBee radios are an efficient and inexpensive mechanism for transmitting low data rate data, such as the sensor data. The Wi-Fi equipment is well suited for the VoIP and video data because, although generally, much more expensive than XBee radios, Wi-Fi has very high data rate capabilities and is an efficient communication mode for higher data rate data, such as VoIP.

At times of peak VoIP and video usage on the network, there may be insufficient capacity in the Wi-Fi communication mode to support all of the VoIP and video data at the desired data rate. In such cases, and in accordance with an embodiment, a lower data rate communication mode, such as the XBee radios, may be used to transmit some of the higher data rate data (e.g., VoIP) that would not normally be able to be transmitted via XBee radio because the data rate needed to effectively transmit VoIP data (e.g., a minimum of 300 kBits/sec, and preferably, 600 kBits/sec) is greater than the data rate capabilities of any single XBee radio (maximum of 250 kBits/second). This is accomplished by multiplexing the VoIP data across multiple XBee radios.

For instance, FIG. 14A shows the relevant components of a first, transmitting network node 2002 (e.g., a communication cube) that desires to transmit high data rate data (e.g., VoIP) to a second, receiving network node 2020. A data stream comprising VoIP data that might normally be transmitted via Wi-Fi communication mode enters a data buffer 2001 at the transmitter 2002. The data buffer 2001 sends the data to a Dynamic Memory Access (DMA) scatter process 2003, which partitions the input data into data blocks of a predetermined size (e.g., each block is 32 bits) and outputs those blocks to N order buffers 2005-1 to 2005-N in sequential order. That is, the first sequential data block in buffer 2001 is sent to order buffer 2005-1, the second sequential data block is sent to order buffer 2005-2, the third sequential data block is sent to order buffer 2005-3, . . . , the N^{th} sequential data block is sent to order buffer N, and then the order repeats, i.e., the N+1^{th} sequential data block is sent to order buffer 2005-1, the N+2^{nd} data block is sent to order buffer 2005-2, and so on until the data in the buffer is exhausted.

It should be understood that the data buffer 2001 may be continuously refilled with data in order that the process may continue on with respect to a data stream comprising more data than can fit within the buffer 2001 at any given instant.

The partitioning is performed in accordance with a predetermined rank and order. As used herein, the term rank refers to the spacing (e.g., in terms of number of bits) in the original data in the data buffer 2001 between a first data block that is sent to any particular order buffer (e.g., order buffer 2005-1) and the next data block that is sent to that same order buffer. Rank may also sometimes be referred to herein as stride. Furthermore, as used herein, the term order refers to the size of the data blocks. Thus, in this exemplary embodiment, the order (the data block size) is 32 bits and the rank (or stride) of the DMA is N×32 bits, because N is the number of order buffers 2005 and 32 is the number of bits in a data block.

The outputs of the order buffers 2005-1 to 2005-N are coupled to the inputs of an N-way chip select Serial Peripheral Interface (SPI) 2007. The outputs of the SPI are coupled to N XBee radios 2012-1 to 2012-N. The SPI is configured to sequentially pass the data block in order buffer 2005-1 to a buffer in radio 2012-1, the data block in order buffer 2005-2 to a buffer in radio 2012-2, the data block in order buffer 2005-3 to a buffer in radio 2012-3, . . . , and the data block in order buffer 2005-N to a buffer in radio 2012-N. The SPI will continuously run through this order, i.e., after it passes the data from order buffer 2005-N to the buffer in radio 2012-N, it will return to the beginning and pass the new data in order buffer 2005-1 to the buffer in radio 2012-1, the new data in order buffer 2005-2 to the buffer in radio 2012-2, and so on, until the end of the data.

In an embodiment, the SPI 2007 communicates with the DMA process 2003 to let the DMA process know when the order buffers are empty (i.e., the data that was written into them has been read out), and, thus, can be refilled with new data. Likewise, the DMA is in communication with the data buffer 2001 (or other processes within the node) so as to receive information as to where the end of the data is.

The XBee radios 2012-1 to 2012-N then transmit the data in their buffers out over their antennas simultaneously, each radio using a different frequency band in order to avoid interference.

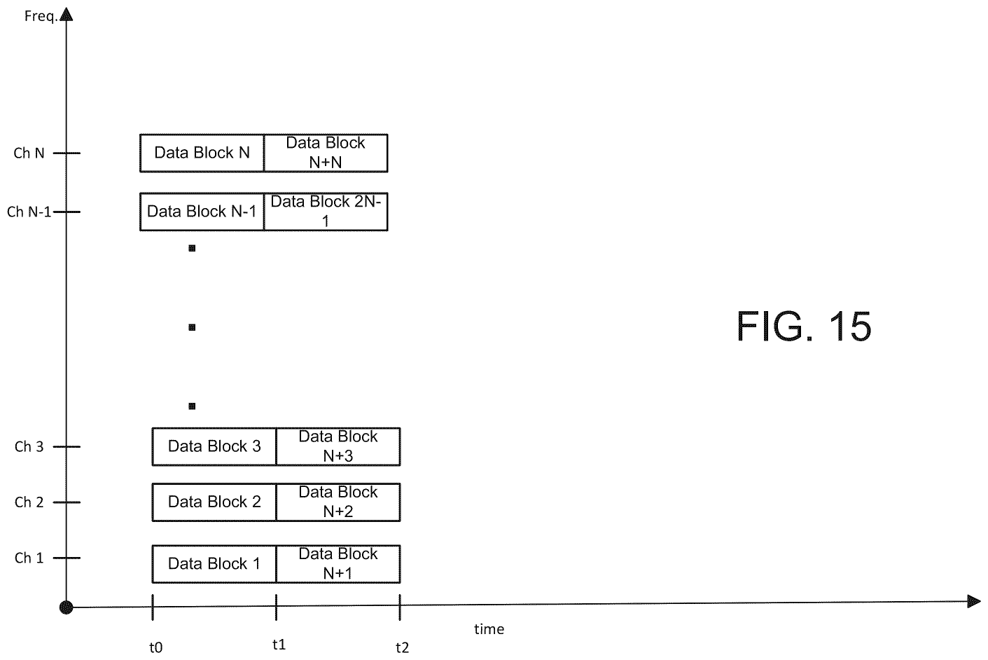

It will be understood by those of skill in the related arts that an SPI is a very fast interface that can fill the buffers in the radios at a faster rate than the rate at which the radios transmit the data out over their antennas. Preferably, that rate that is at least N times faster than the radios can transmit the data over their antennas so that each XBee radio transmits a subset of the data (namely, every N^{th} data block) toward the receiving node simultaneously with little to no down time. Specifically, for instance, with reference to FIG. 15, which is a timing diagram illustrating data block transmission in accordance with an embodiment, from time t0 to t1, radio 2012-1 is transmitting data block 1 in frequency channel 1, while radio 2012-2 is simultaneously transmitting data block 2 in frequency channel 2, radio 2012-3 is simultaneously transmitting data block 3 in frequency channel 3, . . . , and radio 2012-N is transmitting data block N in frequency channel N. Then, between time t1 and t2, radio 2027-1 is transmitting data block N+1, while radio 2027-2 is simultaneously transmitting data block N+2, radio 2027-3 is simultaneously transmitting data block N+3, . . . , and radio 2027-N is transmitting data block N+N, and so on. Thus, the data from the buffer 2001 is being transmitted toward the receiver at a rate much greater than (e.g., N times greater than) the actual data rate of any individual XBee radio.

The data is received at the receiver node 2020 and reassembled in its original order by a process that is essentially the reverse process as that which was performed at the transmitter node 2000.

More particularly, referring now to the receiver node 2020 in FIG. 14A, the data transmitted from radios 2021-1 to 2021-N of the transmitter 2002 is received by radios 2021-1 to 2021-N, respectively at the receiver 2020. Each radio 2021-0-2021-N forwards the received data to an N-way chip select SPI 2023. The SPI 2023 sequentially passes the portions of data received from the radios 2021-1 to 2021-N to order buffers 2025-1 to 2025-N, respectively, such that the data from radio 2021-1 is passed to order buffer 2025-1, the data from radio 2021-2 is passed to order buffer 2025-2, the data from radio 2021-3 is passed to order buffer 2025-3, . . . , and the data from radio 2021-N is passed to order buffer 2025-N, and then repeated until all of the data has been so processed.

The outputs of the order buffers 2025-1 to 2021-N are coupled to the inputs of another DMA process 2027, this one configured to perform a gather process using the aforementioned rank and order. Particularly, the DMA process 2027 outputs the data to a buffer 2029 in order from the data from order buffer 2025-1, followed by the data from order buffer 2025-2, followed by the data from order buffer 2025-3, . . . , followed by the data from order buffer 2025-N, and then starting over with new data in order buffer 2025-1 until all of the data has been written to the buffer 2029 in the proper order to recreate the data that was in transmitter buffer 2001.

Of course, any node that is intended to be able both transmit and receive data using these principles would include both the transmit-side componentry 2002 and the receive-side componentry 2020 shown in FIG. 14A. Any node that is intended only to receive such data may incorporate only the receive-side componentry 2020 and any node that is intended only to transmit such data may incorporate only the transmit-side componentry 2002.

The particular rank and order used by the SPIs and DMAs in the transmitter and receiver nodes, of course, must be coordinated with each other in order for this system to function properly. The rank and order information may be preconfigured in the various components of the receiver and transmitter or may be signaled between the two communication cubes or between a control node of the network and each of the two communication cubes.

Note that, other than any control signaling to coordinate the rank and order between the transmitter and the receiver, little to no control data need be transmitted from the transmitter to the receiver for the receiver to reassemble the data in the proper order. No additional data disclosing the relative position of the data blocks need be incorporated into the data stream between the transmitter and receiver. Rather, only the rank and order need be mutually known by both the transmitter and receiver.

An SPI is merely one example of a device/configuration that can perform the described functionality. Other configurations are possible. What is significant is the afore described functionality, which may be achieved via the use of any type of serial interface combined with a multiplexer/demultiplexer to pass the data from each particular one of a plurality of input terminals (e.g., each input connected to receive the output of a particular order buffer) to a particular output terminal (e.g., each output terminal coupled to the input terminal of a particular radio transmitter).

In fact, the only functional requirement between the order buffers and the radios is that the data in each order buffer be transmitted by each corresponding radio in a known temporal relationship to each other radio transmitter (so that the receiver may reassemble the data in the proper order without the need for express sequence information within (or otherwise accompanying) the data. Thus, for example, an embodiment may be configured such as illustrated in FIG. 14B. The FIG. 14B embodiment is similar to the embodiment of FIG. 14A except that there is a direct connection 2008 between each order buffer and its corresponding radio, rather than the SPI interface 2007. In this embodiment, a software routine (rather than a dedicated device) may assure that the data gets transferred from the buffers to the radios in the proper order (as described above in connection with FIG. 14A). Particularly, the only requirements to assure that the receiving node can reassemble the data in the proper order are that both the transmitting node and receiving node know the rank and order that are being used and that the radios transmit in unison (or at least in a known pattern relative to each other of the radios) without the need to include any additional sequence information within the data transmissions. That can be easily accomplished via software that properly controls the timing of the data transfer from each order buffer to its corresponding radio and/or the timing of the data transmission from each transmitting radio relative to each other transmitting radio.

In fact, in yet other embodiments, software may add sequence information within the data (or otherwise associated with the data), in which case the need for precise timing control of the transmissions by each radio relative to the other radios would not even be important.

The above described embodiment using XBee radios is merely exemplary. The principles described herein above may, of course, be implemented to transmit any type of data using any type of communication mode. Furthermore, it is not necessary that all of the radios in a given network node, e.g., 2012-0 to 2012-N, use the same communication mode, as long as the given transmitter radio (e.g., 2012-1) at the transmitting node and its corresponding receiver radio (e.g., 2021-1) at the receiving node use the same communication mode. It also is possible to use variable orders, i.e., different order buffers and their corresponding radios in a given network node may store data blocks of different sizes (again, as long as the order used in a given radio in the transmitting node matches the order used in the corresponding radio in the receiving node). It also is possible to use different orders at different times. Such embodiments, however, might require additional control data signaling to be transmitted in order to maintain order matching between the corresponding radios in the transmitting and receiving nodes.

The control data mentioned hereinabove (e.g., rank and order data) may be transmitted between the various nodes using the radios 2012 and 2021 or using any other communication mode available at the nodes.

In some embodiments, the data may be run-link-limited encoded so that the data can be decoded at the receiver even if one of the radio channels goes down or the data in one of the multiplexed chains is otherwise lost or compromised.

3. Radio-Based Back Channels for Control Data

The aforementioned low-cost, low data-rate radios, such as XBee, ZigBee, and LoRa radios, offer additional opportunities to offload network traffic to them in order to free up more of the higher-cost, higher data-rate bandwidth and communication modes. Specifically, the XBee, ZigBee, and LoRa communication modes are commonly used in networks for low data-rate data, such as sensor reporting data and other IoT low data-rate data, while the higher data-rate communication modes, such as Wi-Fi, cellular, Bluetooth and Ethernet are used for higher data-rate data, such as voice data, video data, and audio data.

Each of the communication modes, of course, requires significant control signaling that must be transmitted between various nodes of the network in order to keep the network running. That control data uses up much of the communication mode's capacity (i.e., communication resources, such as frequency, time slots, and/or wires). This is particularly true in the case of mesh networks, and especially mesh networks with mobile nodes, which must exchange considerable amounts of data between nodes so that each node can have a reasonably complete knowledge of the location, status, condition, and configuration of the other nodes in the network in order to carry out efficient and reliable communication. Merely a small sampling of the types of control signaling that typically exists in a wireless network include exchanges of modulation and coding schemes to be used for communications, reporting of node geolocation data, and exchanging of measurement data (e.g., signal strength, signal-to-noise ratios, etc.).

In accordance with an embodiment, some or all of the control signaling needed to operate a network of one particular communication mode (e.g., Wi-Fi) may be offloaded to a network of another particular communication mode, e.g., a communication mode that uses different frequency, time and/or wire resources from the first communication mode (e.g., Zigbee, XBee, LoRa).

Such operation can be extremely useful in times when one particular communication mode is overloaded while another communication mode is under-utilized. Merely as an example, in some environments, such as a factory, multi-modal network nodes may use one or more low data rate communication modes, such as ZigBee, XBee, or LoRa, may be used to communicate low data-rate data, such as sensor data, while using a different, higher data-rate communication mode for higher data-rate data, such as voice calls, video data, and/or audio data. Furthermore, it is not uncommon for one of the communication modes to have particularly heavy traffic at certain times (e.g., certain times of the day, certain days of the week, or at random or unpredictable times), while other communication modes are, at those same times, under-utilized. Hence, it would be beneficial to be able to offload some of the traffic in an over-used communication mode/network to a communication mode/network currently being under-used.

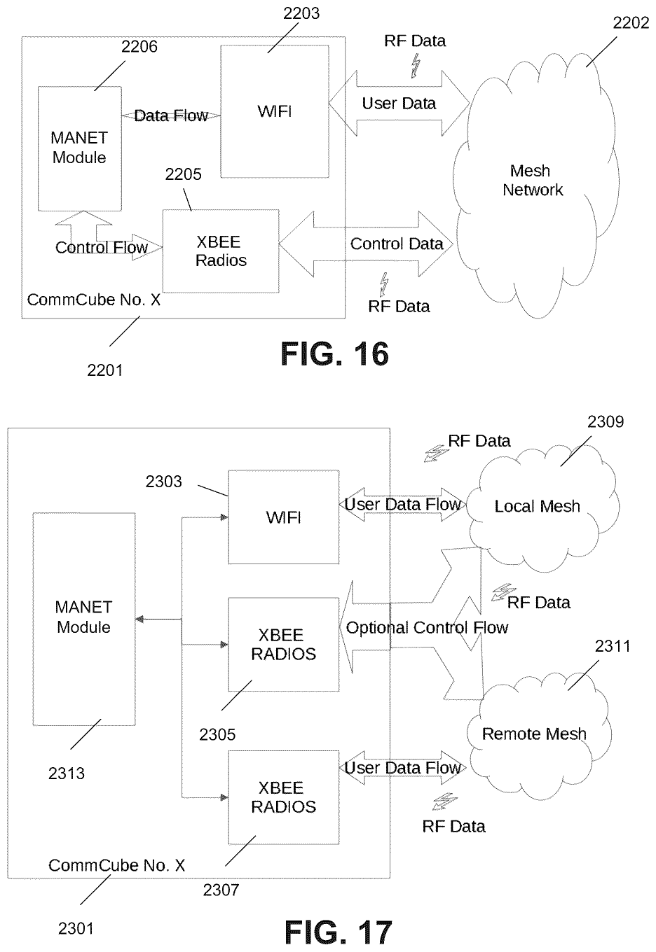

FIG. 16 is a block diagram illustrating the relevant components of a multi-modal network node capable of transmitting and receiving data via multiple communication modes. Such nodes, for instance, may comprise any of the communication cubes described hereinabove.

For purposes of describing an exemplary embodiment, FIG. 16 shows a communication cube 2201 as one such node of a mesh network 2202. The communication cube 2201 includes at least componentry that provides Wi-Fi capability 2203 and componentry that provides XBee capability 2205. The network 2202 is a mesh network, and thus, the node 2201 has a mesh management module, such as a MANET (Mobile Ad hoc NETwork) management module 2206. More particularly, module 2206 may be software running on an appropriate processor configured to execute a routing protocol for a multi-hop mobile ad hoc network. In typical MANET-based Wi-Fi mesh networks, the MANET Management module 2206 may process both control plane data and user plane data for transmission to other nodes via a high data rate modality, such as the Wi-Fi radio componentry 2203.

However, in accordance with an embodiment, the MESH Management module 2206 may be modified to transmit and receive the Wi-Fi network's control plane data via a lower bandwidth network/communication mode, such as the XBee radio module 2205, instead of through the Wi-Fi module 2203 (each XBee system 2305, 2307 may have capability to transmit multiple data streams wirelessly simultaneously, such as the N radios 2012 or 2021 illustrated in FIG. 14A). This operation frees up capacity in the Wi-Fi network for a greater amount of user plane data to be transmitted and received over the Wi-Fi resources, as there is no need to use up those resources transmitting control data. The modifications to the MESH Management module 2206 to implement such an embodiment may be minimal. For instance, the MESH Management module 2206 may be reconfigured to transmit and receive the control plane data through a different set of ports than the user plane data.

The embodiment of FIG. 16 is merely exemplary. For instance, in other embodiments, when a lower data-rate network/modality is overburdened, its control plane data may be offloaded to a higher data-rate network/modality.

This concept also may be expanded to further include the offloading of some of the user plane data to a network of a different communication mode. For instance, referring to the alternate embodiment illustrated in the block diagram of FIG. 17, a node 2301 of a mesh network may have at least componentry 2303 for communicating with other network nodes via Wi-Fi 2303, as well as componentry for communicating with other nodes via XBee in the form of at least two XBee radio systems 2305 and 2307. Each XBee system 2305, 2307 may have capability to transmit multiple data streams wirelessly simultaneously, such as the N radios 2012 or 2021 illustrated in FIG. 14A.

The node 2301 is a multi-modal node in a first Wi-Fi network, herein called the local mesh network 2309. However, in addition, there is another Wi-Fi network 2311, herein termed the remote mesh network. In this example, the local mesh network 2309 and the remote mesh network 2311 are spaced far enough from each other geographically that they are not within Wi-Fi radio range of each other (i.e., no Wi-Fi node of network 2309 is within range of any node of remote network 2311). For instance, Wi-Fi radios typically have a maximum range of about 100 feet. Therefore, let us assume that the closest nodes of Wi-Fi networks 2309 and 2311 are over 100 feet from each other.

On the other hand, XBee radios commonly have communication ranges of about 1 kilometer. Accordingly, two Wi-Fi networks can be out of communication range of each other, but within XBee radio communication mode range of each other. In such a case, the two Wi-Fi networks can exchange control plane data with each other via an XBee radio, e.g., radio 2305, using the same principles discussed above in connection with FIG. 16 even though they are not within Wi-Fi range of each other.

The MESH management module 2313 may be configured to transmit and receive the Wi-Fi network control plan data via the first set of XBee radios 2305, rather than via the Wi-Fi componentry 2303. Thus, the MESH management modules in the nodes of both networks can have access to all the control data of both networks 2309 and 2311, thereby having the ability to form a super Wi-Fi mesh network including the nodes of both the remote mesh network 2311 and the local mesh network 2309. User plan data may continue to be exchanged within the local mesh network 2309 using the Wi-Fi componentry.

However, by adding another XBee radio, e.g., radio 2307, user plane data also may be exchanged between nodes of the two WiFi networks 2309 and 2311 via the XBee radios. For instance, data exchanges that involve small amounts of user data and/or low data rate user data may be exchanged between the local Wi-Fi network 2309 and the remote Wi-Fi network 2311 via the second XBee radio 2307. In fact, in some embodiments, even large amounts of data may be so exchanged, e.g., using the data multiplexing concepts disclosed above in connection with FIGS. 14A, 14B, and 15.

Of course, it will be understood by those skilled in the relevant arts that a second XBee radio 2307 is merely an exemplary embodiment. In other embodiments, the same functionality may be achieved with a single XBee radio. Particularly, the MESH management module 2313 may be configured to use some channels of a single XBee radio for exchanging control plane data and other channels of the same XBee radio to exchange user plane data.

Only one XBee-enabled node of each of the local network and the remote network need be within XBee radio range of each other to enable such embodiments. Particularly, once the data reaches any node of the destination Wi-Fi network, it can be further exchanged within that destination Wi-Fi network using Wi-Fi. Hence, a super Wi-Fi network comprising the Wi-Fi capable nodes of both the local mesh network 2309 and the remote mesh network 2311 collectively may form a super Wi-Fi mesh network.

Even further, if some of the nodes of one or both of the local mesh network 2309 and the remote mesh network 2311 are mobile, then it is possible that one or more nodes of the local mesh network could, at times, be within Wi-Fi range of one or more nodes of the remote network. Since the MANET modules 2313 of at least one node in each network already has the control data for the nodes of both networks (which likely includes geolocation data of the various nodes), the MANET module 2313 can detect such a condition and quickly start using Wi-Fi, instead of XBee, to exchange data between nodes of the two networks during periods when such conditions exist.

4. Interconnection of Diverse Mesh Networks into a Single Controlled Mesh

In networks that include at least one node with multiple communication mode capabilities, such as the communication cube nodes discussed in this disclosure (see, e.g., FIGS. 1-3), such multi-modal nodes may be configured to provide communication between the nodes of different networks of different communication modes. For instance, consider an exemplary communication cube having Wi-Fi, Ethernet, Cellular, PLC, XBee, Bluetooth, LoRA, and ZigBee communication capabilities. With respect to each of those communication modes, the communication cube may be a node of a network of that communication mode. Thus, for instance, this exemplary communication node may be a node in a Wi-Fi network, a node in a cellular network, a node in a PLC network, a node in an XBee network, a node in a Bluetooth network, a node in a LoRa network, and a node in a ZigBee network. Some or those networks may be mesh networks.

Any of those networks may further include other nodes that are multi-modal nodes (e.g., other communication cubes). In addition, any of those networks may also include other nodes that are not multi-modal. For example, some devices, e.g., sensors and other IoT devices, may have communication capabilities in only one of those modes, e.g., sensors that can communicate only via XBee radio or Wi-Fi nodes that can communicate only via Wi-Fi.

Nodes having non-overlapping communication mode capabilities cannot communicate with each other directly. In fact, even nodes that have overlapping communication modes cannot communicate with each other directly if they are parts of different networks.

Thus, in accordance with an embodiment, a multi-modal node, such as a communication cube, may be adapted to provide a doorway between two or more networks of different communication modes (or the same communication mode) so that the nodes of different networks that could not otherwise communicate with each other directly (either because they have non-matching communication modes or because they are on different networks of the same communication mode) can communicate with each other. Particularly, a multi-modal gateway node may be provisioned with the capability to convert all communications (i.e., packets, messages, etc.) received in any of the communication modes within its communication mode capabilities to an “exchange” protocol (which may be the protocol of any one of the communication modes within its capabilities or a completely different protocol than the protocol of any of the communication modes within its capabilities). Then, it may process the packet data as well as its routing to a next hop node in that protocol to, inter alia, determine a next hop node of any communication mode within that node's communication mode capabilities. Finally, it converts the packet from the exchange protocol back into packets of the selected protocol of the selected next hop node.

The exchange protocol is so named because its primary characteristic is that communications in any one of the other communication protocols within the capabilities of the doorway node can be converted into communications of any other one of the communication protocols within the capabilities of the doorway node via the exchange protocol, and vice versa. This type of node is herein named a “doorway” node for similar reasons.

The doorway node has a map of the nodes of each of the networks of which it is a member. It also runs a routing algorithm that permits routing to the destination node specified in the communication via any communication mode and/or network accessible to the doorway node. Thus, for example, if the doorway node is part of one or more mesh networks, it may receive packet via XBee radio destined for a node having only Wi-Fi capability. The doorway node converts the packet from XBee protocol to the exchange protocol, reads the destination address, determines the best route to the destination node based on the relevant criteria (e.g., signal strength, data rates, load balancing, signal to noise ratio, shortest distance, fewest number of hops, etc.), converts the communication to the communication protocol of the selected communication mode, and transmits the communication along that route.

There may be multiple such doorway nodes in the path of any given packet or communication. Hence, at each such doorway node, the communication may be processed as described above (i.e., the communication protocol may be changed).

Any of the communication cubes discussed herein may be adapted to operate as a doorway node in accordance with these embodiments.

In the following discussion of exemplary embodiments, the exchanged data will be referred to as packets for ease of reference, but it should be understood that the methods, apparatus, and systems described herein are agnostic to the form of the communication and that “packet” is merely an exemplary form of a piece of data being communicated via a network. Finally, the following discussion will refer to specific communication modes, e.g., Wi-Fi, cellular, XBee, as examples, but it should be understood that these are merely exemplary and that the concepts disclosed herein may be applied across virtually any two or more communication protocols.

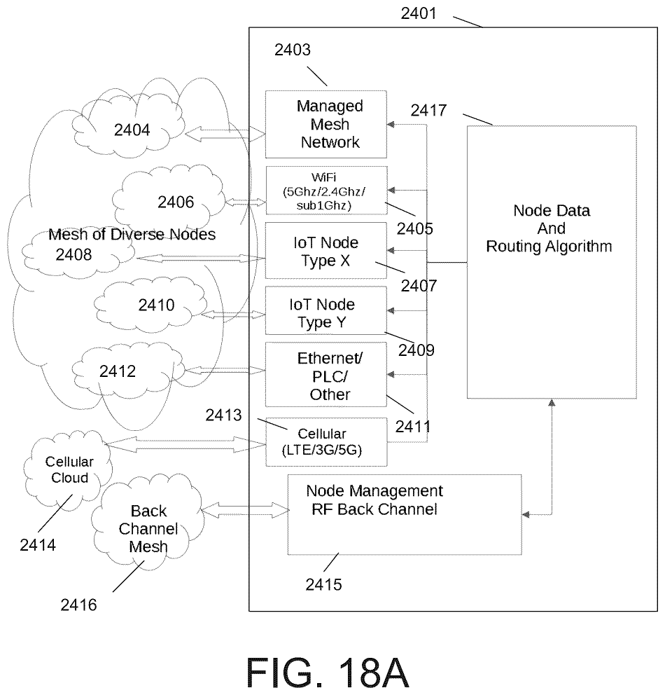

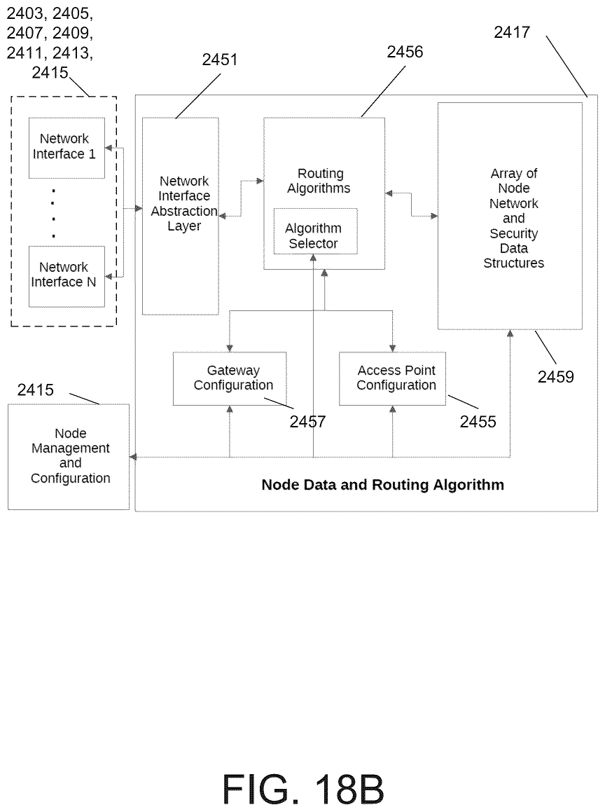

FIG. 18A is a block diagram of components of a network node operable in a multi-mesh environment in accordance with embodiments. FIG. 18B shows the node data and routing algorithm block of FIG. 18A in more detail. Referring to FIG. 18A, a communication cube is configured as one of the doorway nodes. The doorway node 2401 may have the componentry and functionality of any of the communication cubes heretofore discussed, such as any of the communication cubes of FIGS. 1-3. However, only the components and functionality relevant to the present discussion are shown in FIG. 18A. The gateway node includes interfaces 2403, 2405, 2407, 2409, 2411, 2413, and 2415 for a plurality of different communication modes. These interfaces may correspond to interfaces that might be found within the elements 121, 221, and 321 in FIGS. 1, 2, and 3, respectively.

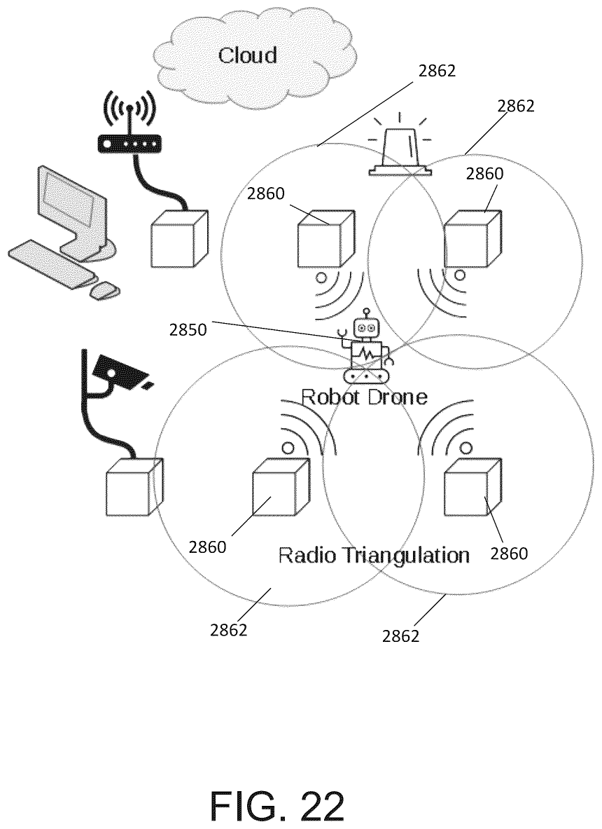

More specifically, interface 2403 is an interface to a managed mesh network 2404, e.g., a Wi-Fi managed mesh network. Interface 2405 is an interface to another Wi-Fi network 2406, but not a mesh network. Interface 2407 is an interface to an IoT node of a first communication mode type, e.g., XBee 2408. Interface 2409 is another IoT type interface of a different network protocol, e.g., ZigBee network 2410. Interface 2411 is a wire type interface, e.g., Ethernet or PLC, to an Ethernet or PLC network 2412. Interface 2413 is an interface to a cellular network 2414, such as an LTE or 5G network. Finally, interface 2415 is a special interface for back channel communication of control data for the other networks, such as discussed above in connection with the embodiments of FIGS. 21 and 22. That is, as in the embodiments of FIGS. 21 and 22, network resources on the other networks may be maximized for carrying user data by offloading some or all of the control signaling for those networks to a separate network, such as an XBee mesh network 2416.

A Node Data and Routing Algorithm block 2417 is the component that runs the algorithm that determined the routing of packets through the various networks from the source node to the destination node. It also converts incoming packets in the protocol of the network from which it is incoming to the exchange protocol, and also converts packets from the exchange protocol to the protocol of the network on which the packet will be sent back out on its path toward the destination node.

In operation, the communication cube 2401 receives data packets on any of the interfaces 2403, 2405, 2407, 2409, 2411, 2413 in the format consistent with the protocol for that type of network. Note that it also may receive relevant control information for the relevant network from the back channel mesh network 2416 via the back channel interface 2415. The packet is forwarded to block 2417, where it is converted to the exchange protocol. As noted above, the common protocol may be a new protocol different from the protocols of any of the networks 2404, 2406, 2408, 2410, 2412, 2414, 1416. However, it also could be a protocol of one of those networks, in which case, packets received through the interface corresponding to that type of network would not need any conversion. Once the data in the packet is converted to the exchange protocol, the routing algorithm can examine the various relevant parameters of the data in the packet, such as the source address, the destination address, any intermediate nodes/addresses that the packet has passed through, and determine a forwarding route for the packet to its next hop (or to its final destination address depending on the routing scheme employed). In order to determine an efficient routing, the routing algorithm must have access to all of the relevant information about the status of the various nodes of the various networks (or, more precisely, about the links between the various nodes of the various networks). Such information may include, merely as a few examples, signal to noise ratios, signal strengths, loads, data rates, network types, and any other data that is typically used in network routing algorithms to determine forwarding pathways for packets such as has been discussed previously in this specification. The doorway node 2401 keeps track of all such data, also as previously discussed.

Once the forwarding route has been determined, the packet data is converted to the protocol of the network of the next hop for the packet (unless it happens to already be in that protocol, in which case, no conversion may be needed).

In some cases, the selected route may be to a node in the same network that the data arrived from or a different network but of the same communication mode as the network from which the data arrived. Hence, in such cases, the packet would be converted back to the same protocol in which it originally arrived at the doorway node 2401.

Since, in this embodiment, the control signaling has been moved to the back channel network, some of the routing control signaling may need to be transmitted in the back channel 2416.

The Node Data and Routing Algorithm block 2417 may be implemented as software running on a processor, as hardware, or as a combination of software and hardware.

5. Use of Radio Frequency Back Channels to Enhance Security

In a MESH or mobile ad hoc network (MANET) network with mobile nodes, such nodes may leave and join the network as they move about. Of course, stationary nodes also may join and leave networks at various times and for various reasons, such as adding new nodes to expand the range of the network, removing old nodes for repair or maintenance, and equipment failure, as some examples. As is well known in the art of communication networks, when a node joins a network, typically, there are a number of processes that must be performed between the new node and the core network to get that node up and running on the network. Such processes include proper authentication (e.g., assuring that the node is allowed to join the network), configuring the node to operate in accordance with the protocols and parameters of the network, assigning it a network-specific address, assigning a network gateway, testing its various operating parameters, geo-locating the node, etc.

One of the first processes usually performed is to authenticate the node, i.e., confirm that it is a node that is allowed to join the network. Commonly, a network might maintain a database of devices (i.e., nodes) that are allowed to join the network, commonly referred to as an access control database, access control list, or a whitelist. The devices that are allowed to join the network may be identified in the database by their component MAC addresses, for instance. If the network uses public-private key encryption, the access control database may also include the public key of each device that is allowed to join the network. The access control database may be located at one particular node of the network, which node is accessible to the other nodes of the network via the network. In this manner, a joining node can communicate with any node already in the mesh network and be authenticated by that node through a network query to the access control database.

In an embodiment, the authentication of a node (such as a communication cube) attempting to join a network (such as a mesh network comprising nodes with multiple communication mode capabilities (such as Wi-Fi, Ethernet, PLC, XBee)), may be performed using one of the low data rate communication modes, such as XBee, ZigBee, or LoRA.

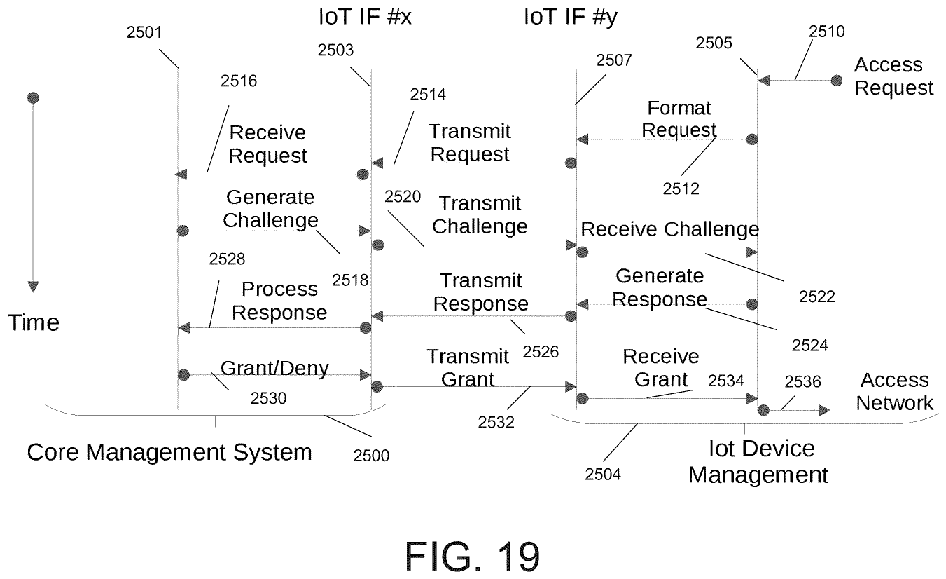

FIG. 19 is a signal flow diagram illustrating the signal flow for an authentication process in accordance with such an embodiment. The two entities represented by vertical lines 2501 and 2503 toward the left in the diagram represent entities in the core network 2500. These entities are the core network management system 2501 that runs the processes related to authentication of new nodes and a radio 2503, such as an XBee radio that the core network management system 2501 uses to communicate with other nodes of the network. The two entities represented by vertical lines 2507 and 2505 toward the right in the diagram represent entities in the device 2504 that is attempting to join the network. These entities are the IoT device management system 2505 of the device 2504 that runs the processes related to authentication and the device's XBee radio 2507.

When the device 2504 determines that it wishes to join the network 2500 (e.g., it has detected that its geo-location is within range of the network or it has picked up a signal from the network, thereby indicating that it is within range of the network), the device 2504 generates an access request 2510 to join the network. The IoT Management process 2505 formats the request for radio transmission by the XBee radio 2507 and sends the formatted access request 2512 to the radio 2507. The radio 2507 transmits an access request message 2514 over the air to the network. The XBee radio 2503 of one of the nodes of the network receives the access request message 2514 and forwards it (see message 2516) to the core network management system 2501. As previously noted, the core management system 2501 may be in the same node as the receiving radio 2503 or may be in a completely different node of the network.

The core management system 2501 generates an authentication challenge 2518 for the device and sends it to the radio 2503. Essentially, the challenge is a request for the device to send the network information about the device so that the network can authenticate the device (i.e., establish that the device is allowed to join the network). As noted above, that information may be a public encryption key, a MAC address, or any other data used by that particular network for authenticating nodes. The radio 2503 transmits the challenge message (2520) to the device 2504. The radio 2507 of the device 2504 receives the challenge message 2520 and forwards it (2522) to the IoT management system 2505.

The IoT management function 2505 generates a response 2524 to the challenge 2522. This challenge response 2524, for instance, may comprise the unique MAC address of the device so that the network can compare that MAC address to the MAC addresses in its access control database to see if it finds a match). The challenge response 2524, which may be in the form of an access request packet, is sent to the radio 2507, which transmits the challenge response (message 2526) to the radio 2503 in the network. The radio 2503 feeds the challenge response (see message 2528) to the core management process 2501, which processes the challenge response to determine if the device is allowed to join the network (e.g., has a MAC address matching a MAC address in the list of approved devices).

The core management system 2501 then generates and sends a grant 2530 (or a denial if the device is not approved) to the radio 2503, which transmits the grant/denial (see message 2532) to the radio 2507 of the device, which forwards the response (see message 2534) to the IoT management function 2505. If the response is a grant, the device 2504 may then perform any other functions necessary to join the network and, afterward, join the network (2536).

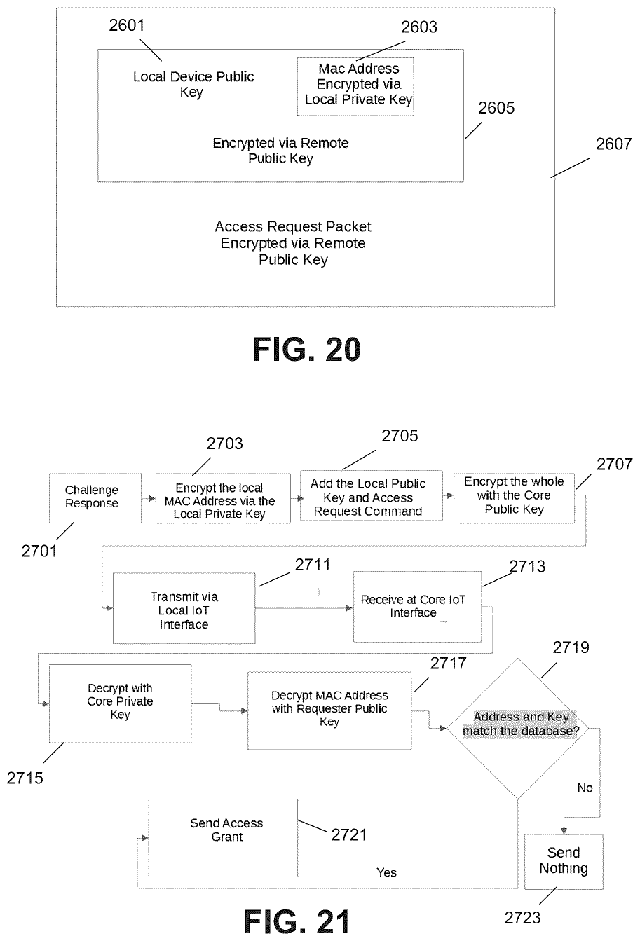

FIG. 20 is a diagram showing the contents of an exemplary access request packet 2605 in accordance with an embodiment that enhances security of the network by making it very difficult for an illicit node to be admitted to the network. In this embodiment, the data that is used to authenticate a node is its MAC address and the public key of that node. Thus, the relevant information in the access request packet 2605, i.e., the relevant information in signals 2524, 2526, 2528 of FIG. 19 comprises the MAC address 2603 and the public encryption key 2601 of the device that is attempting to join the network.

For added security, the MAC address 2603 is encrypted using the private encryption key of the device 2504. Next, the public key of the device 2601, the encrypted MAC address 2603, and any other parts of the access request packet 2605 are further encrypted using the public key of the network. This encrypted access request packet 2605 is inserted into the challenge response 2524 message and gets transmitted to the network radio 2503 in challenge response message 2526 of FIG. 19 (it should be obvious that it also forms at least a part of signal 2528 from network radio 2503 to core management system 2501

In an alternate embodiment, the entire encrypted access request packet 2605 may be encrypted with the public key of the network.

FIG. 21 is a flow chart representation of the steps for authenticating a device joining a network in accordance with this exemplary embodiment. The steps in the top line of FIG. 21 (i.e., steps 2701, 2703, 2705, and 2707 essentially correspond to the creation of the access request packet 2605 as described immediately above in connection with FIG. 20. Also note that FIG. 21 essentially represents much of the same the process described in connection with the signal flow diagram of FIG. 19 starting after step 2522.

Particularly, the joining device creates a challenge response template at 2701. At 2703, the MAC address of the device is encrypted using the private encryption key of the device and inserted into the challenge response template. At 2705, the public encryption key 2601 of the device is inserted into the challenge response template. Then, at 2707, the encrypted MAC address and the public key of the device are further encrypted using the public key of the network. Next, at 2711, the joining device transmits the challenge response to the network (corresponding to message 2526 in FIG. 19).

At the network, the Core Management System IoT interface (e.g., radio 2503 in FIG. 19) receives the challenge response message (2713). Then, at 2715, the network decrypts the entire challenge response message with the network's private key (the counterpart to the network's public key, which the device used to encrypt the entire message) to retrieve the device's public key, and the still-encrypted MAC address (still encrypted with the device's private key). Next, at 2717, the network decrypts the MAC address with the device's public key, which it has just received in the same challenge response message and stores the MAC address in a table (access control table).

Now, the network can check the device's unencrypted MAC address against the MAC addresses in its access control database to confirm the identity of the device as a device that is allowed to join the network (2719). If the database also stores the public keys of the devices that are allowed to join the network, then it can also check in step 2719 if the public key that it just received from the device matches the public key in its database corresponding to the MAC address it just received.

If the data matches, it grants access to the device (2721). If not, it does nothing (2723), and the device cannot join the network.

This scheme provides enhanced security because, in order to be properly authenticated, a device must establish both that (1) its MAC address is in the list of approved device MAC addresses and that it is using the private-public key pair that matches the expected key pair for the device having that MAC address. Furthermore, because of the two layers of encryption, the messages containing the MAC address of the joining device are protected from illicit eavesdropping.

6. Communication Cubes in Mobile Devices, Such as Robots, Autonomous Vehicles, and Drones

In certain networks, some of the nodes of the network may be mobile nodes, while other nodes are stationary nodes. Probably the most well-known form of a mobile node is a cellular telephone of a cellular network. However, as the Internet of Things (IoT) grows, it will be increasingly common to have mobile nodes in more local networks, such as Wi-Fi networks. Mobile nodes in such networks may include devices such as Wi-Fi enabled cellular telephones, drones, robots, autonomous carts, and other autonomous vehicles. In such networks, it is necessary to provide communication to and from such nodes as they move about an environment. Also, in most cases, it will be desirable to track the precise physical location of the mobile nodes, either or both because part of the functionality of the node may require the network and/or other nodes of the network to know the node's location (e.g., which fire suppression robot in a factory network is closest to a fire) and/or for purposes of routing communications through the network, especially a mesh network, wherein the geo-location of a node is information that may be used in determining the routing path for data through the network.

With reference to FIG. 22, which shows a network environment including stationary and mobile nodes, in an embodiment, a mobile device, such as a drone, autonomous vehicle, or robot 2850 may be equipped with a communication cube (not shown separately), such as any of the communication cubes discussed in connection with FIGS. 1-3 with at least one wireless communication capability, such as Wi-Fi. For exemplary purposes, let us assume that the mobile node is a drone capable of freely moving around a factory. A communication cube with wireless communication capabilities, such as Wi-Fi, especially one with the mesh network features discussed hereinabove can provide all of the connectivity and communication capabilities needed to provide communications between the drone 2850 and the network. In an embodiment, the geo-location of the drone may be determined (and tracked over time) by using trilateration techniques to locate the communication cube in the drone at any given time.

In a preferred embodiment, the communication cube in the drone is configured to provide and manage the connectivity to the network and the routing of all communications between the drone and the network as well as provide the triangulation functionality. The responsibility for all other functionality of the drone may remain with the other processing equipment within the drone.

With regard to geo-locating the drone, either or both the communication cube within the drone and/or a node of the network may be configured to calculate the geo-location of the drone using trilateration (or, alternately, triangulation). Particularly, in one embodiment, a trilateration process is performed in the communication cube embedded in the drone 2850. In one embodiment, the drone may be configured to determine its distance from at least three stationary nodes 2860 of the network. For instance, in one embodiment, the communication cube in the drone may request all of the network nodes within communication range to transmit to the drone a reference signal that includes at least the location of the node that sent the message, and a time stamp at to the time when the message was transmitted. When the drone receives each of those messages, it determines the time difference between the time stamp in the message and the time that it received the message. Since the radio waves travel at a known speed, this delay period defines the distance between the drone and the node that sent the message. As is well known, this distance defines a sphere 2862 around the transmitting node 2860 having a radius equal to the measured distance between the drone 2650 and the stationary node 2860 that the drone must be geo-located on.

With the knowledge of the geo-location of at least three different stationary nodes 2860 and the distance to those three nodes (i.e., knowledge of three non-co-located spheres on which the drone must be located), the drone can mathematically calculate the single point where those three spheres intersect, which point is the geo-location of the drone. Since there are errors and/or tolerance limits to the distance measurements, the greater the number of stationary nodes 2860 that respond to the request for a reference signal, the greater the number of mathematical spheres on which the drone 2850 must lie, and thus the greater the accuracy with which the location of the drone 2850 may be determined.

In some embodiments, the drone may also analyze signal phase information in the reference signals, and can increase the accuracy of the trilateration positioning determination by also determining the phase delays of the multiple reference signals received.

In other embodiments, the location may be determined via triangulation rather than trilateration with or without the assistance of signal phase analysis.

7. MESH-Chain Information Security

In accordance with certain embodiments, the security of data stored within a network, particularly, a mesh network, may be enhanced by taking advantage of the network structure itself. In an embodiment, a unit of data (e.g., a data file, such as a word processing document, photograph, video, database, encryption security key, etc.) may be split into multiple segments, and the various segments stored in the memories of different nodes of the network. The nodes at which the various segments are stored may be randomized, such as by use of a random number generator in an algorithm that selects the nodes at which the various segments will be stored. A key may be generated that contains the information as to the locations of all of the segments (e.g., the node of the network and the memory address within that node at which each segment is stored), and including the order in which they must be reassembled to re-create the original file.

The key may be stored at a node within the network. However, to further enhance security, the key may instead be stored in a memory that is not accessible to the network (e.g., a separate memory device that is not connected to any network, such as a USB thumb drive or at a node of a different network).

This scheme makes it extremely difficult for a cyber-criminal to access the information in the original file, as he/she must, not only gain access to the key, but also gain access to every node of the network that contains a segment of the original file.

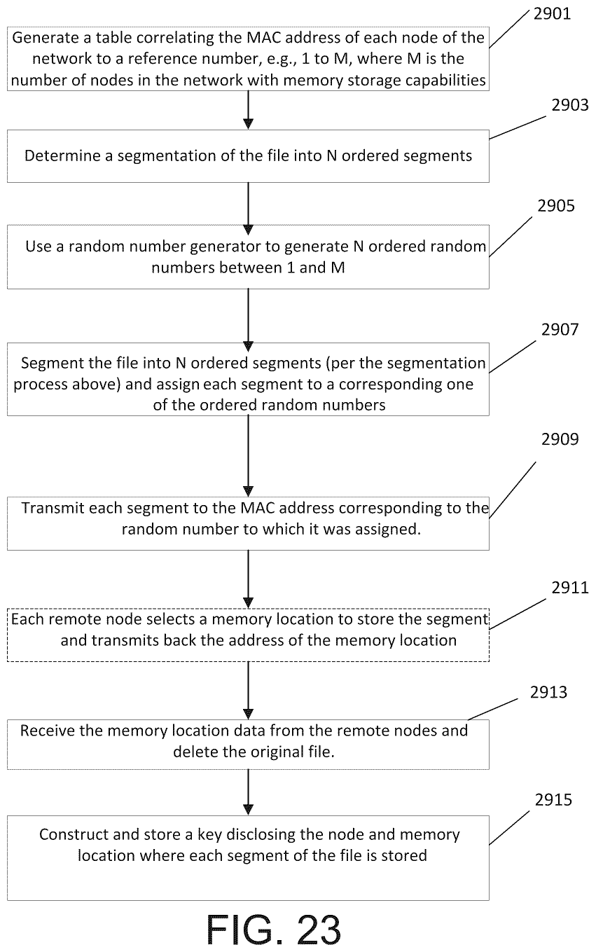

FIG. 23 is a flowchart illustrating a process in accordance with this embodiment. At step 2901, a table is generated that correlates each of M nodes of the network to a reference number. A reference number may be assigned to every node of the network (in which case M is equal to the number of nodes in the network) or to a subset of the nodes of the network. The table should be limited to network nodes that have available memory. The network nodes may be identified in the table by their MAC addresses.

At step 2903, a segmentation plan for segmenting a unit of data (hereinafter referred to as an exemplary file for ease of reference) into N segments is created. N may be any integer. However, in a preferred embodiment, N may be made equal to M such that there will be one segment of the file for each usable node of the network. The file need not be actually segmented at this point.

Next, at step 2905, a random number generator (RNG) generates N random numbers, wherein the random numbers that can be generated by the RNG are limited to the set of M reference numbers. For example, if the network comprises 100 nodes that are usable for data storage, then the M numbers may be whole numbers from 1 to 100, and the RNG generates a random number from 1 to 100.

The RNG may, for instance, take the form of any of the RNGs described in aforementioned U.S. Published Patent Application No. 2023/______ (patent application Ser. No. 17/398,224, entitled METHODS AND APPARATUS FOR MULTI-PATH MESH NETWORK ENCRYPTION AND KEY GENERATION) filed Aug. 10, 2021.

In an embodiment, assuming that M is greater than or equal to N, the RNG algorithm may be configured so that, when it generates the N random numbers, no number is repeated. This configuration would maximize the number of nodes to which segments are sent. However, on the other hand, adding such a restriction on the generation of the random number, might decrease the true randomness of the random numbers generated. Thus, in other embodiments, no such restriction may be imposed.

Next, at step 2907, the original file is segmented into N segments and each segment is assigned one of the random numbers that were generated in the preceding step in an ordered manner. By the term ordered, it is meant that data is maintained as to the order of the N segments so that the original file can be reconstructed from the N segments by placing them back together in the original order.

Then, at step 2909, the node transmits each of the N segments to the MAC address (i.e., the node having that MAC address) corresponding to the random number that was assigned to each segment in step 2901 along with instructions to store the segment at that node.

Next, at step 2911, each remote node to which a segment was transmitted reports back the memory location at that node at which the segment was stored. This scheme allows each node to manage its own storage.

However, in other embodiments, the node having the original file may select both the remote nodes to which the data segments will be transmitted as well as the memory locations in those nodes at which the segments are to be stored. This type of embodiment would eliminate the need for the remote nodes to report the memory location information back to the originating node, thereby reducing network traffic and risk of capture by cyber sniffing. However, this would require the originating node to have complete knowledge of the state of the memory at each of the remote nodes to which it is sending the segments. This might often be impractical or impossible. Also, it is advisable to have the remote nodes at least acknowledge receipt and proper storage of the segment so that the originating node will know that all segments of the file have been received and properly stored. Thus, in such embodiments, the remote nodes would be sending back an acknowledgement in any event, and it requires only minimal additional resources to include the memory location with that acknowledgement message.

At 2913, the node receives the acknowledgement and memory location data from the remote nodes to which it sent the file segments.

Finally, at 2915, the node constructs a key (a path key) containing the information needed to reconstruct the original file from the segments. In its simplest form, this information comprises the node and memory address within that node of each segment of the original file and the correct order of those segments. The key may be encrypted to further enhance security. The original file may be deleted at this point (or at any point subsequent to step 2913).

In embodiments, the original file actually may remain at the originating node, but its original contents deleted and replaced with the key. In this manner, when one needs to access the original file, one may still gain access to the file via accessing the file's original location using its original filename at the originating node. Of course, the file will no longer be located at that location, but the key to finding the segments of the file and reassembling them in the proper order will be found there.

When it is time for a user to access the file, that user merely needs to be given (1) the key, (2) access to the network, and (3) a program that reads and interprets the key, retrieves the segments from the remote nodes as dictated by the key, and reassembles them in the order dictated by the key.

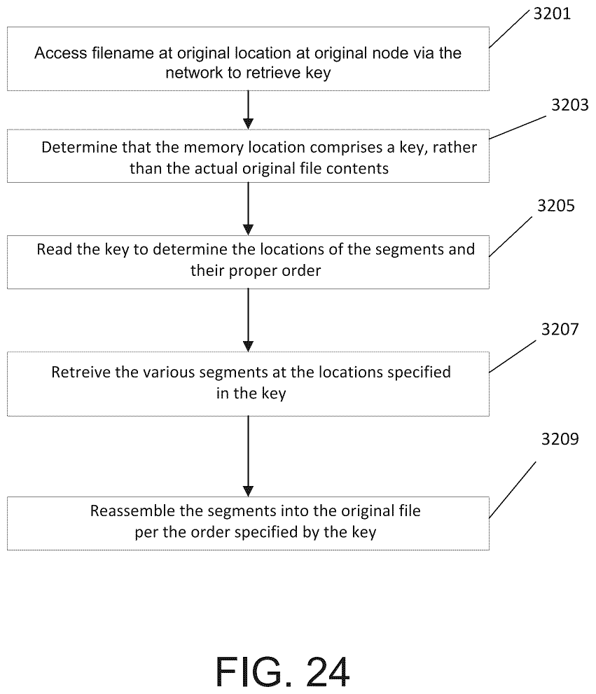

FIG. 24 is a flowchart illustrating an exemplary embodiment of an operation for retrieving such a segmented file from the network.

Particularly, at step 3201, a user at a node of the network may request the file at its original location using the original file name using conventional network file accessing techniques. However, rather than finding the file contents there, it will find the key (the path key).

At step 3203, the user node detects that the accessed location contains a key in accordance with the principles of this embodiment, rather than the actual original file contents. The program at the user node, of course, will be equipped with software or other means for detecting when the contents of the file are a key. This may be as simple as detecting a known bit sequence (e.g., a flag) at the beginning of the data stored at the location (which flag would have been placed there when creating the key in step 2915 of FIG. 23).

Responsive to detecting the flag or other indication that the contents are a key, rather than the original file contents, at step 3205, the accessing node initiates a program or other means to read the key determine the number of segments, the locations of the segments of the file, and their proper order. If the key is encrypted, it will also decrypt the key first.

Then, at step 3207, the accessing node sets about retrieving each segment from the locations specified in the key.

Finally, at step 3209, the accessing node reassembles the original file from the segments using the ordering that also is specified in the key.

8. Burst Mode

In many networks, there may be a desire to minimize wireless transmissions and/or to concentrate wireless transmissions within certain time periods. For instance, in military scenarios, it may be desirable to make a network as undetectable as possible by concentrating all wireless communications into brief periods such that, most of the time, there are no radio transmissions from the network that can be detected by hostile forces, thus rendering the network effectively undetectable by radio monitoring for radio signals from the nodes of the network most of the time. Additionally or alternately, in some military or commercial application there may be a desire or need to concentrate wireless transmissions in time due to the ability for the receiving device (for example a satellite or aircraft) to handle the data traffic only at certain times, e.g., due to range, position, or stealth concerns.

Furthermore, regardless of stealth issues, it may be desirable to operate a wireless network only periodically for purposes of power management. For instance, in some networks, some or all of the nodes may operate on battery power or intermittent power (e.g., solar power). Transmitting and receiving wireless signals is one of the most power hungry operations of network nodes. Accordingly, it may be desirable to have such nodes perform their other duties (e.g., collecting and storing data from sensors at the node, calculations, wired communications with other nodes, etc.) more frequently or even continuously while avoiding any wireless communications, and then wirelessly transmit all of the collected data in a burst in order to conserve battery life.

In accordance with embodiments, network nodes may be configured to save for an extended period of time data that is intended to be transmitted wirelessly and then transmit all of that stored data in widely spaced wireless transmission bursts of relatively short durations (e.g., durations shorter than the duration of the spaces between the burst radio transmissions).

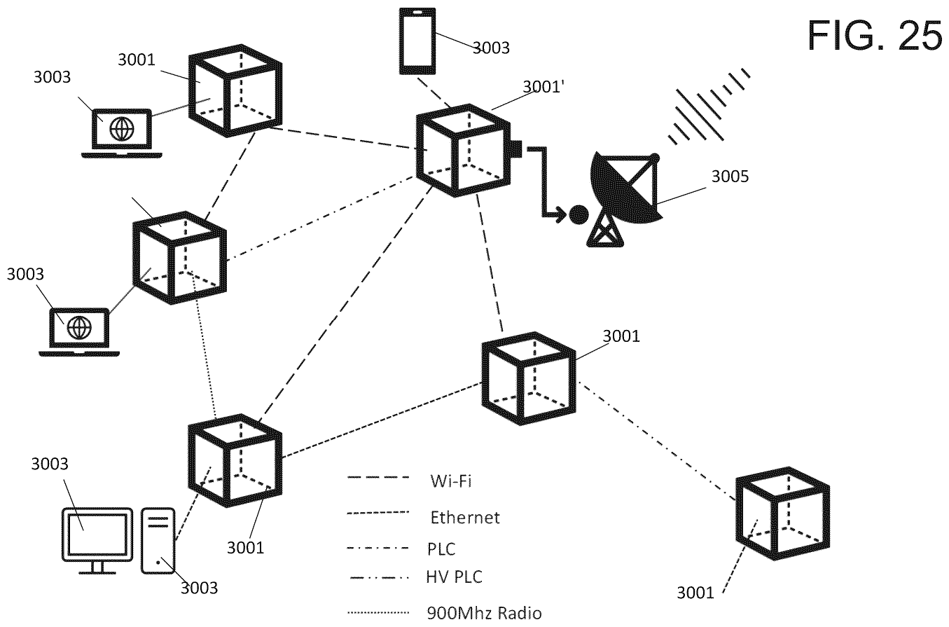

With reference to FIG. 25, a network of communication cubes 3001, such as any of the communication cubes described hereinabove in connection with FIGS. 1-3, for instance, a mesh network of communication cubes, is particularly amenable for such burst applications due to, inter alia, their multi-modal communication capabilities and mesh capabilities.

Specifically, with respect to nodes that have both wired communication modalities (e.g., Ethernet, PLC) and radio/wireless communication modalities (Wi-Fi, cellular, ZigBee, XBee, LoRa), they may operate in states where wired communications between nodes of the network are performed continuously or much of the time, while the wireless communication modalities are disabled most of the time. Then, at certain intervals and for certain durations, any data that needs to be transmitted or received that could not or was not transmitted/received via wired communication modalities may be transmitted/received via a wireless communication modality in burst mode.

For instance, in a military environment, data may be gathered, calculated, and/or developed by a variety of devices 3003 (e.g., sensors, computers, telephones) and transmitted to local communication cubes 3001 associated with those devices. Those communication cubes may store the data while waiting for a burst mode interval. Also, some of those communication cubes may be able to transmit some or all of the collected data via wired communication modalities to one or more other nodes for temporary storage so that a single node may wirelessly transmit data originating from a plurality of nodes.

Such operation will allow the network to remain undetectable via radio eavesdropping during the periods between wireless bursts. Furthermore, generally, wired transmissions require substantially less energy than wireless transmissions. Hence, substantial battery or other power savings still may be achieved by operating the wired communication modes continually while the wireless communication modalities operate in burst mode, rather than continuous mode.

Furthermore, operating wired communication modalities continuously and wireless communication modalities only periodically enables the network to be operated in a manner in which, for instance, the various nodes of the network with wired communication capabilities can exchange all of the data that will ultimately need to be transmitted wirelessly for one reason or another, to a single node (or a subset of nodes), such as communication cube 3001′, which can wirelessly communicate with a satellite radio 3005. Then, that node may wirelessly transmit all of that data collected from all of those nodes in burst fashion via the satellite 3005.

One of the advantages of such operation include the fact that only one node of the network, e.g., node 3001′, will be exposed to possible radio detection during the burst transmission. Further, typically, a single node transmitting a given amount of data generally can transmit that data using less overall energy than multiple nodes transmitting the same amount of data separately.

In addition, the network may be configured such that the node (or subset of nodes) that perform(s) the wireless burst transmission may change for each burst transmission. Such operation would make it even more difficult to surreptitiously detect the location of the nodes of the network insofar as it often may take detection of more than one burst transmission from a given node before its location can be zeroed in on with sufficient precision by an enemy combatant or other malevolent entity. Switching the transmitting node each burst transmission will confound attempts to determine the location of any given node over multiple burst transmissions. Furthermore, changing the node that transmits/receives during the burst mode will spread the energy consumption for wireless transmissions more evenly among the nodes of the network, thereby helping to prevent any one node from running out of battery power significantly earlier than any other node.

Yet further, even if the location of a node (or even a relatively small number of nodes) were determined by a hostile entity and disabled, a mesh network likely would still be able to continue operating largely unfettered by the loss of a single node or a few nodes.

In embodiments, the burst intervals (the periods during which the wireless bursts are transmitted) may be 1 percent or less of the duration of the off intervals (the periods during which wireless transmissions are disabled). Preferably, the duration of the burst intervals is less than 1/10 of 1 percent of the duration of the off intervals.

In embodiments, the burst interval may be limited to a certain maximum duration, but may be shorter than the maximum duration if the data that needs to be transmitted does not require the full allowable burst interval. The maximum allowable burst duration may be set as a function of a reasonable estimation of the amount of time it would take to locate the source of a transmission by a hostile entity. This may depend on many factors, including the strength of the transmission signal, the terrain from which the signal is emanating, the amount and nature of other radio signals and noise in the surrounding area, the number of nodes in the network that can transmit data wirelessly, etc.

In embodiments, the burst intervals may be regular or irregular. In one preferred set of embodiments, the bursts intervals are irregular so that a hostile entity cannot reasonably predict when they will occur, thus making it even more difficult to detect.

In other embodiments, the burst intervals may be a function of the amount and/or the type of the data that needs to be transmitted wirelessly. For instance, in one simple embodiment, the burst interval may occur whenever the amount of data that needs to be wirelessly transmitted reaches a certain threshold. That threshold may be the amount of data that can be transmitted within the maximum allowable burst interval as discussed above.

In embodiments, a maximum period between burst intervals may be specified (i.e., a maximum duration of the off interval). This may be desirable so that it may be determined if the network is still operational when there is a long gap between the need for wireless data transmissions. In yet other embodiments, a minimum amount of data ready for wireless transmission may be configured before a burst transmission will be initiated.

While the examples discussed herein have focused on network nodes that need to transmit data, it should be understood that, in other scenarios, the network nodes may need to receive data wirelessly or both transmit and receive data wirelessly during the burst modes, and the principles described hereinabove may be equally applied to reception as well as transmission of data.

Another non-military example of a scenario wherein such operation may be extremely useful is a wired network of nodes that collect data of some sort in a remote location that does not have cellular service, e.g., monitoring of the operation of oil rigs and other oil extraction equipment in the ocean, or collection of data about flora and fauna in a remote jungle. The nodes of the network may collect data continuously and communicate with each other via wired connections (or even low power wireless communications such as XBee or Wi-Fi), but save the transmission of such data to a (e.g., to a location where humans are located who can analyze the data) for certain burst intervals (e.g., high power satellite radio transmission when the receiving satellite is overhead).

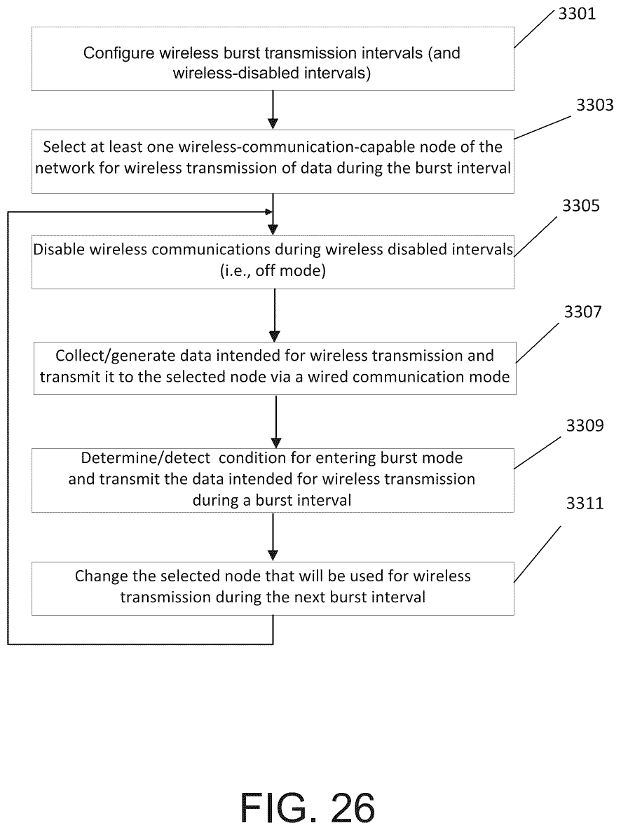

FIG. 26 is a flow diagram illustrating one exemplary process in accordance with this embodiment incorporating many of the exemplary features discussed hereinabove.

At 3301, the network in configured with the parameters of the burst intervals (and complementary wireless-disabled (or non-burst) intervals). As noted above, some of the parameters include the duration of one or both types of intervals, the amount of data that must be ready for transmission before starting a burst interval, a maximum duration threshold for a burst interval, etc.

At 3303, the network further selects a subset of nodes that will be used to transmit data during the next burst interval. As noted above, this may comprise one or more wireless-communication-mode-capable nodes.

Then, at 3305, the network is configured to disable wireless communications (i.e., to enter the off mode). In step 3307, during the off intervals, the nodes of the network may collect and/or generate data that is intended for wireless transmission (and, of course, may continue to do so during the burst intervals also). They also may transmit the data to the node that will be used for the burst transmission. As noted above, these transmissions may be limited to wired transmissions. However, as also noted above, in other embodiments, the off intervals may only involve the disabling of certain wireless communication modes, while still permitting other wireless communication modes. At 3309, the network (or at least one of the nodes of the network) detects a condition required to commence a burst transmission and commences the burst transmission. As previously noted, the condition may be an amount of data that is waiting for wireless transmission, expiration of a timer, etc.

After the burst transmission is completed, at 3311, in order to enhance the security and stealth of the network, a different node is selected for the wireless transmission during the next burst interval. Then flow returns to 3305, where wireless communications are disabled again (i.e., re-enter off mode).

9. Channel Switching in Mesh Network to Optimize Security and Network Operation

Many wireless communication protocols, including standards-based protocols such as Wi-Fi (based on the IEEE 802.11 family of protocol specifications) have multiple predefined channels over which devices may communicate with each other using that particular protocol.

Note that the 802.11 specifications specify several different frequency bands in which Wi-Fi systems may operate, including one band around 2.4 GHz (2.400-2.500 GHz) and one band around 5 GHz (4.915-5.825 GHz). Within each of those bands, there are multiple channels, each channel comprising a smaller frequency range within the frequency band which devices may use for communication. Specifically, for example, in the 2.4 GHz band, there are 14 channels, each channel spaced apart by 5 MHz, the first channel being centered at 2.412 GHz and the last channel being centered at 2.484 GHz. In the 5 GHz band of Wi-Fi, there may be 36 to 165 bands depending on various factors.

Continuing with the example of 802.11 in the 2.4 GHz band, a wireless network operating in accordance with the protocol typically selects one of the channels within the band to use for communications within that network, and the network operates on that channel unless and until a significant event occurs that requires the network to change bands. Such an event, for example, might be human-operator intervention. Typically, a device configured to operate within the wireless protocol includes a Network Interface Card (NIC) that controls the operation of the device as it pertains to interfacing with the wireless network. A multi-modal device that is capable of operating using multiple, disparate communication protocols, such as the CCs, MCCs, and PCCCS described hereinabove typically will have a NIC for each such communication protocol. Furthermore, a processing system, e.g., a Raspberry Pi processor, may be configured to control each NIC to operate as required for the given protocol. For instance, each NIC may be provisioned (via the Raspberry Pi processor) with a configuration file that contains information about how that NIC should operate on the network of the given communication protocol. For instance, among other things, the configuration file will contain a piece on information specifying the channel within the protocol that it should use for communications.

In order to switch to a different channel within the protocol, the configuration file in the NIC corresponding to that communication protocol must be updated, and then, after the update, the NIC must be rebooted (so that it reads the configuration file again and sees the new channel assignment and configures its interfaces accordingly). Altering a configuration file to switch channels is typically done manually by a human operator on the rare occasion of a need or desire to switch channels. Such a need or desire may arise, for instance, when the local environment has changed so as to cause operation on a particular channel to become less desirable. For instance, if a business moves in next door with a lot of equipment that throws off a significant amount of radio noise at a particular frequency, it may be desirable to switch a WLAN (Wireless Local Area Network) nearby to a channel that is far away from the noise.

In accordance with an embodiment for enhanced network security, the network may be monitored for security breaches, and, if and when such a breach is detected, all of the authorized nodes of the network are controlled to switch to a new channel within the communication protocol in order to thwart any unauthorized access to the network. Any unauthorized nodes eavesdropping or otherwise using the network will not receive the control command to switch channels and thus will effectively be kicked off the network.

More specifically, in a mesh network, typically, there is at least one node, e.g., a gateway node, that can send configuration messages to all other nodes in the network (either directly or through a multi-node path through the mesh). Thus, in an example, a security software suite runs on the network and monitors the network for unauthorized access, such as detection of a node operating on the network that is not authorized to operate on the network (e.g., a node having a MAC address that is not in the list of authorized MAC addresses). The security software may take any form, and there are many commercially available network security suites available for most wireless communication protocols that include such functionality for detecting unauthorized nodes using the network.

The security suite may send a message to the proper network entity, such as a gateway node, indicating that an unauthorized node has been detected. In response, the gateway node, e.g., the Raspberry Pi processor running on that node that is tasked with controlling network operations, may send a configuration message to all of the authorized nodes of the network informing them to change to a specified channel. In an embodiment, the message may contain a new configuration file with which each node is to replace its old NIC configuration file. Alternately, the message may contain instructions to change the line of code in the configuration file specifying the channel that the node is to use for communications.

Each node, e.g., the Raspberry Pi processor in charge of network interface functioning at each node, may be provisioned with an onboard script designed to respond to such a message by taking the relevant information from the message (e.g., the new configuration file or new channel number) and replacing or reconfiguring the NIC configuration file accordingly, followed by rebooting the node. The gateway node, of course, does not send the message to any unauthorized node(s), and thus, the unauthorized nodes will be effectively kicked off the network as they will not know the new channel.

In embodiments, rather than rebooting the node, the script may instead restart the Wi-Fi service, which might lessen the period during which the network is down for channel switching.

In either case, when the node reboots or the service restarts, the node will read the new or updated configuration file and thus restart on the newly assigned channel.

In certain cases, the unauthorized node may try to gain access to the network again by searching for the new channel on which the network is operating. However, this may be difficult and, at a minimum, would take a significant amount of time to regain unauthorized access. In addition, as soon as the new unauthorized access is detected, the network can follow the same procedure described above to switch channels again.

In some embodiments, the channel switching process such as described above may be performed randomly or at preset times irrespective of an actual detection of a network intruder. This embodiment may be useful in thwarting unauthorized accesses that might not be detected by the network's security suite.

In yet other embodiments in networks comprised of multi-modal nodes, the scripts may be configured to, instead of switching channels within a given protocol, actually switch communication protocols. For instance, if the nodes of the network all have communication capabilities for 802.11 at 2.4 GHz, 802.11 at 5 GHz, Ethernet, and a 900 MHz radio protocol, then, in response to detection of an unauthorized node or other security breach, the scripts at the nodes may be configured to switch between bands (e.g., switch from 802.11 at 2.4 GHz to 802.11 at 5 GHz) or even between protocols (e.g., switch from 802.11 at 2.4 GHz to a 900 MHz radio protocol, Ethernet, or PLC, etc.). As noted above, this may also be done randomly to thwart the potential of undetected network eavesdropping and the like.

In one embodiment, the script may be configured to react to such a message by simply turning off the current protocol. This type of operation will have a similar result as multi-modal nodes of a network commonly will already be configured with a process for switching to another communication mode/protocol when one mode goes down.

In some embodiments, the script may be configured to perform channel switching multiple times in a row in response to repeated detection of security breaches, but when it determines that it has had to switch channels a predetermined number of times within a predetermined period of time, then it switches to switching protocols (or bands), rather than just channels within a single protocol.

While the invention has been described hereinabove mostly in connection with exemplary embodiments assuming the primary communication protocol of 802.11 at 2.4 GHz, it should be understood that this is merely exemplary, and that the concepts discussed hereinabove may be applied to any communication protocol.

10. Network Splitting and Operating Multiple Networks in the Same Space

There are many circumstances under which a wireless network may be configured sub-optimally for its particular location and/or mission. Merely as an example, as previously noted, there are two disparate bands within the IEEE 802.11 protocol, namely, the 2.4 GHz band and the 5 GHz band. In fact, many commercially available wireless network routers are capable of selectively providing service in either band or in both bands simultaneously. It is also well known that radio wave communications at lower frequencies generally penetrate obstacles (walls, windows, buildings, etc.) better than radio wave communications at higher frequencies. It also is well known that, generally, radio communications at higher frequencies are capable of providing greater data rates than radio communication at lower frequencies. Thus, an 802.11 network operating in the 2.4 GHz band in a given environment generally will have greater range (geographic range) than one operating in the 5 GHz band. However, on the other hand, one operating in the 5 GHz band generally can provide a faster data rate than one operating in the 2.4 GHz band.

In fact, even within a single band of a radio communication protocol having multiple channels within the band, the channels within that band that are at the lower end of the spectrum are likely to show better range performance than the channels at the higher end of the band (and vice versa with respect to data rate).

In a given network environment, there may be times during which greater range is more desirable than greater data rate and other times during which greater data rate is more desired than greater range. Likewise, there may be circumstances under which certain nodes of a network would benefit more significantly from greater range than greater data rate, while other nodes would benefit more significantly from greater data rates rather than greater range.

Even further, regardless of either range or data rate considerations, a single network may be performing sub-optimally simply because there is too much radio traffic in the band and/or too much interference from other sources for the network to provide the expected or desired speed and/or quality of service.

In accordance with embodiments, a wireless network may be configured to split the nodes in a single network into two (or more) separate groups and cause those groups of nodes to operate essentially independently as two different wireless networks (that do not interfere with each other).

In some embodiments, the network may be configured to detect one or more undesirable conditions that would likely be ameliorated by splitting the nodes of a single network into two groups as described above. The condition(s) may comprise almost any network service quality indicator, such as SINR (Signal to Interference and Noise Ratio), SNR (Signal to Noise Ratio), RSRP (Reference Signal Received Power), BER (Bit Error Rate), etc. It also may comprise an analyzed aspect of the network user data traffic. For instance, if it is detected that a certain subset of nodes in the network are communicating exclusively or almost exclusively with each other, then that subset of nodes may form a group that is split off into a separate network. For instance, a single network operating in the 802.11 protocol at 2.4 GHz and comprising 21 nodes may detect that 5 nodes of the network have been communicating exclusively or almost exclusively with each other for a certain period of time and that they are exchanging data at a very high data rate and are in close geographic proximity of each other (e.g., a group of 5 individuals are playing a video game with each other). The network may decide to split those 5 nodes off and reassign them to an 802.11 network at 5 GHz. Those 5 nodes are still within geographic range of the other 16 nodes of the network, but have essentially been offloaded to another frequency band well outside of the possibility of significantly interfering with the communications of the original network and also freeing up significant bandwidth in the original network. In embodiments, the network may be configured to split off such nodes only if it simultaneously determines that the original network is suffering performance shortfalls due to a high volume of traffic.

In some embodiments, the network may be configured to split nodes into different channels within a single band, instead of switching bands.

In other embodiments, groups of nodes may be switched to different communication protocols (e.g., switch from 802.11 to Ethernet, cellular, PLC, etc.).

There are many such circumstances under which it might be beneficial to split off some nodes from other nodes, including, but not limited to:
Enhancing performance: For instance, performance may be degraded in the original network due to excessive traffic in a given channel, band, or protocol. Alternately, there may be interference between communications on adjacent channels within a wireless protocol;
Enhancing security/privacy: For instance, a certain subset of nodes may need to exchange extremely sensitive or confidential data exclusively or almost exclusively with each other;
Expansion of service: For instance, as more nodes join a network and/or the nodes start to generate more traffic, it may be desirable to have multiple networks operating in the same area to handle the increased traffic.

In accordance with an embodiment, the network may be monitored for conditions indicative of an opportunity to benefit from network splitting as described herein above. As previously mentioned, some examples of such conditions include quality of service or other performance degradation meeting certain criteria. Wireless networks generally are already provisioned with numerous features for monitoring quality of service and communication performance for many other reasons. Such features can be repurposed (or, more accurately, additionally purposed) to trigger network splitting operations as described above.

Likewise, scripts may be enabled for detecting subsets of nodes that communicate exclusively or almost exclusively with each other (e.g., over predetermined lengths of time).

Provision may be made for a user interface by which a human operator may instruct the network to split off a subset of nodes, such as for privacy or security reason as discussed above. It also is possible to automatedly detect the type of data being exchanged between certain nodes and determine from the type of data that it is highly sensitive or private data (or at least highly likely to be so).

Then, when such a condition is detected, the subset of nodes in question may be controlled to switch to a new channel, band, or communication protocol as described.

More specifically, in a mesh network, typically, there is at least one node, e.g., a gateway node, that can send configuration messages to all other nodes in the network (either directly or through a multi-node path through the mesh). Thus, in an example, a software suite runs on a node of the network and monitors the network and individual nodes of the network for any one or more of the aforementioned types of conditions.

In some embodiments, the software suite may send a message to the proper network entity, such as a gateway node, indicating that such a condition has been determined and may include in the message data as to which nodes should be separated into one or more groups. In other embodiments, e.g., embodiments where the detected condition is fairly general to all nodes (e.g., there is too much traffic in the network), it may be left to the gateway to decide the grouping(s).

In response, the gateway node, e.g., the Raspberry Pi processor running on that node that is tasked with controlling network operations, may send a configuration message to all of the nodes in the group to cause them to operate in another channel, band, or protocol. Such message may include any information necessary for the node to do so (such as the new channel, band, or protocol). The message may contain a new configuration file with which each node is to replace its old NIC configuration file. Alternately, the message may contain instructions to change the line of code in the configuration file specifying the channel, band, or protocol that the node is to use for communications.

Each node, e.g., the Raspberry Pi processor at that node that is in charge of network interface functioning, may be provisioned with an onboard script designed to respond to such a message by taking the relevant information from the message (e.g., the new configuration file or information) and replacing or reconfiguring the NIC configuration file accordingly, followed by rebooting the node. The gateway node, of course, does not send the message to any node(s) that are going to continue operating in the original network configuration, and thus, those nodes continue to operate largely unaffected by the change. Of course, in a mesh network, the routing tables may need to be updated in view of the loss of some of the nodes previously in the network.

When the node reboots or the service restarts, the node will read anew the configuration file, and restart on the newly assigned channel, band, or protocol.

As mentioned above, there may be situations where two nodes that have been configured to communicate on different channels, bands, or communication modes from each other in accordance with these embodiments do need to exchange data (e.g., once or on rare occasions). In such cases, one of the nodes can switch over to the communication channel, band, or mode used by the other for a brief period to exchange the data, and then revert to the previous channel, band, or communication mode. Of course, this would knock that node off of its network for a short period.

However, in another embodiment, a bridge node may be provisioned in the network that consistently operates (or at least monitors for signals) in the multiple communication channels, bands, and/or modes such that any node in any of the multiple networks can send it a message at any time (either directly or through the mesh of the mesh network it is operating on). Thus, when it is necessary for a first node operating on one of the networks to transmit a message to a second node operating in another/split network, the node can simply send the message to the bridge node, which can reconfigure the message as needed to transmit it onto the other network and forward it to the intended destination node in that other network. For instance, co-owned U.S. patent application Ser. No. 17/705,664, which is incorporated herein fully be reference, discloses a mesh network system in which messages in a first communication protocol are converted to messages in a second communication protocol for transmission between nodes in separate networks, and such technology may be applied for the above-described scenario.

In yet other embodiments, rather than splitting a single network into two disparate networks operating on different channels, bands, or communication modes, a single network operator/administrator may initially set up two (or more) separate networks in a given area that operate in different channels or a given communication protocol, operate in different bands of a given communication protocol, and/or operate in different communication protocols so as not to interfere with each other. Again, as previously discussed, the selection of which nodes are in any given one of the two or more networks may be based on security, traffic congestion, privacy, primary function/purpose of a node, etc.

The operator could even set up a bridge node that is communicatively coupled to at least one node in each of the networks so that messages can be exchanged between nodes in the two (or more) networks through the bridge nodes, if and when necessary or desired. Merely as one example, an Ethernet bridge node may be coupled (via wire) to at least one node in each of two separate 802.11 networks wireless networks, e.g., a first network operating in the 2.4 GHz band and a second network operating in the 5 GHz band. Any messages that need to be transmitted from any node in the first network to any node in the second network can be sent to the bridge node (either directly via Ethernet or via the wireless mesh of the first network), and the bridge node can transmit it into the second network for forwarding to the intended destination node in the second network (either directly via Ethernet or through the wireless mesh of the second network).

### CONCLUSION

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 1822 containing instructions 1824 so that a device connected to the communications network 1435, another network, or a combination thereof, can send or receive voice, video or data, and communicate over the communications network 1435, another network, or a combination thereof, using the instructions. The instructions 1824 may further be transmitted or received over the communications network 1435, another network, or a combination thereof, via the network interface device 1820.

While the machine-readable medium 1822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

We claim:

1. A method of storing an original data file in a communication network comprising:
splitting the original data file into N ordered segments, where N is an integer greater than 1;
assigning each of the N segments to a node of the network capable of storing data;
transmitting each of the N segments to the network node to which it has been assigned;
constructing a key containing information as to the network node at which each segment of the original data file is stored and an order of the segments; and
deleting the original data file.

2. The method of claim 1 wherein the assigning of each of the N segments to a node of the network comprises randomly assigning each of the N segments to one of M nodes of the network, where M is an integer greater than 1.

3. The method of claim 2 wherein the randomly assigning of each of the N segments to one of M nodes of the network comprises:
correlating a Media Access Control (MAC) address of each of the M nodes to a different number;
using a random number generator to assign each of the N segments a number between 1 and M; and
assigning each of the N segments to the network node corresponding to the number the segment was assigned.

4. The method of claim 3 further comprising:
receiving, via the network, from each network node to which a segment was transmitted an indication of the memory location at which the corresponding segment was stored; and
storing in the key the memory location at which each segment was stored.

5. The method of claim 1 further comprising:
storing the key at a memory location at which the original data file was stored and with the same name as the original data file.

6. The method of claim 1 further comprising reconstructing the original data file by:
retrieving the key;
determining the locations of the N segments of the original data file and the order of the segments based on the key;
retrieving the segments via the network; and
reassembling the segments into the original data file.

7. The method of claim 6 wherein retrieving the key comprises:
attempting to access the original data file at its original location using its original file name; and
determining that the data stored at the original location and under the original filename is a key rather than the original data file.

8. A method of transmitting data wirelessly in a mesh network comprised of a plurality of network nodes having multi-modal communication capabilities, including wireless communication modes, the method comprising:
determining first intervals during which communication via wireless communication modes will be disabled in the mesh network and second intervals during which communication via wireless communication modes will be enabled;
disabling wireless communication modes of the nodes of the mesh network during the first intervals;
during the first intervals, storing data that is intended for wireless transmission in at least one node of the mesh network; and
during the second intervals, wirelessly transmitting the stored data that is intended for wireless transmission from at least one node of the mesh network.

9. The method of claim 8 wherein the wireless transmissions during the second intervals are transmitted from a selected subset of nodes of the network during each second interval.

10. The method of claim 9 wherein the selected subset of nodes from which the wireless transmissions are transmitted during the second intervals is changed each second interval.

11. The method of claim 9 wherein the selected subset of nodes comprises a single node.

12. The method of claim 9 wherein the duration of the second intervals is shorter than the duration of the first intervals.

13. The method of claim 8 further comprising:
transmitting data between the nodes of the network via wired communication modes during the first intervals.

14. The method of claim 8 wherein at least some of the plurality of network nodes are authorized nodes operating in a first communication mode on a first communication frequency channel, the method further comprising:
determining a security breach in the network; and
responsive to a detection of a security breach of the network, transmitting a first message to the authorized nodes of the network operating in the first communication mode on the first communication frequency channel instructing the authorized nodes to switch to a second communication frequency channel.

15. A method performed in a radio communication device attempting to join a communication network of authenticating the radio communication device to the network, the method comprising:
(1) encrypting a Media Access Control (MAC) address of the radio communication device using a private encryption key of the radio communication device;
(2) encrypting a copy of a public encryption key of the radio communication device and the encrypted MAC address using a public encryption key of a network it is attempting to join;
(3) transmitting the encrypted copy of the public encryption key and encrypted MAC address to the network;
(4) responsive to step (3), receiving from the network permission to join the network; and
(5) joining the network.

16. The method of claim 15 wherein the radio communication device and at least one node of the network have multi-mode communication capabilities including a first radio communication mode of a relatively higher data rate and a second radio communication mode of a relatively lower data rate, and wherein the transmitting and receiving steps are performed over the second radio communication mode.

17. The method of claim 16 wherein the second radio communication mode is one of XBee, ZigBee, and LoRa.

18. The method of claim 17 further comprising:
receiving an authentication challenge message from the network; and
wherein steps (1) and (2) are performed responsive to receiving the authentication challenge request from the network.

19. The method of claim 18 further comprising:
transmitting a request to join the network prior to step (1); and
wherein the authentication challenge message is received in response to the request to join the network.

20. The method of claim 16 further comprising:
placing the encrypted copy of the public encryption key and encrypted MAC address in an access request packet in accordance with a protocol of the network.
